(19) United States
(12) Patent Application Publication
(10) Pub. No.: US 2018/0342067 A1
(43) Pub. Date: Nov. 29, 2018

(54) MOVING OBJECT TRACKING SYSTEM AND MOVING OBJECT TRACKING METHOD

(71) Applicant: KABUSHIKI KAISHA TOSHIBA, Minato-ku (JP)

(72) Inventors: Hiroo SAITO, Kawasaki-shi (JP); Toshio Sato, Yokohama-shi (JP); Osamu Yamaguchi, Yokohama-shi (JP); Hiroshi Sukegawa, Yokohama-shi (JP)

(73) Assignee: KABUSHIKI KAISHA TOSHIBA, Minato-ku (JP)

(21) Appl. No.: 16/053,947

(22) Filed: Aug. 3, 2018

Related U.S. Application Data
(62) Division of application No. 13/588,229, filed on Aug. 17, 2012.
Application No. 13/588,229 is a continuation of application No. PCT/JP2011/053379, filed on Feb. 17, 2011.

(30) Foreign Application Priority Data
Feb. 19, 2010 (JP) 2010-035207
Sep. 13, 2010 (JP) 2010-204830

(51) Int. Cl. G06T 7/20; H04N 5/14

(52) U.S. Cl. CPC G06T 7/20; G06T 2207/30241; G06T 2207/20076; H04N 5/144

(57) ABSTRACT

A moving object tracking system includes an input unit, a detection unit, a creating unit, a weight calculating unit, a calculating unit, and an output unit. The detection unit detects all tracking target moving objects from each of input images input. The creating unit creates a combination of a path that links each moving object detected in a first image to each moving object detected in a second image, a path that links each moving object detected in the first image to an unsuccessful detection in the second image, and a path that links an unsuccessful detection in the first image to each moving object detected in the second image. The calculating unit calculates a value for the combination of the paths to which weights are allocated. The output unit outputs a tracking result.

### CROSS REFERENCE TO RELATED APPLICATIONS

This application is a divisional of U.S. application Ser. No. 13/588,229, filed Aug. 17, 2012 which is a continuation of PCT Application No. PCT/JP2011/053379, filed Feb. 17, 2011 and based upon and claiming the benefit of priority from prior Japanese Patent Applications No. 2010-035207, filed Feb. 19, 2010; and No. 2010-204830, filed Sep. 13, 2010, the entire contents of all of which are incorporated herein by reference.

### FIELD

Embodiments described herein relate generally to a moving object tracking system and a moving object tracking method.

### BACKGROUND

A moving object tracking system, for example, detects moving objects included in frames in a time series of images, and matches identical moving objects between frames, thereby tracking a moving object. This moving object tracking system may record a tracking result of a moving object or identifies a moving object in accordance with the tracking result. That is, the moving object tracking system tracks a moving object, and conveys a tracking result to an observer.

The following three techniques have been suggested as the main techniques for tracking a moving object.

According to the first tracking technique, a graph is created from the result of a detection of adjacent frames, and a problem for finding matching is formulated as a combinational optimization problem (problem of assignment on a bipartite graph) that maximizes a proper evaluation function, such that objects are tracked.

According to the second tracking technique, in order to track an object even when there are frames in which the moving object cannot be detected, information on the surroundings of the object is used to complement a detection. A concrete example is a technique that uses, in face tracking processing, information on the surroundings, for example, the upper part of the body.

According to the third tracking technique, an object is detected in advance in all frames of moving images, and the frames are linked together to track objects.

Furthermore, the following two methods have been suggested to manage tracking results.

The first tracking result managing method performs matching so that the moving objects can be tracked at intervals. According to the second managing method, a head region is detected and kept tracked even when the face of a moving object is invisible in a technique for tracking and recording a moving object. If there is a great pattern variation after the moving object is kept tracked as the identical person, records are separately managed.

However, the above-described conventional techniques have the following problems.

First, according to the first tracking technique, matching is performed only by the detection result of the adjacent frames, so that the tracking is interrupted when there are frames in which detections are unsuccessful during the movement of the object. The second tracking technique has been suggested as a technique for tracking the face of a person and uses information on the surroundings, for example, on the upper part of the body to cope with an interrupted detection. However, the problem of the second tracking technique is that this technique requires means which is adapted to detect parts other than a face and which is not adapted to the tracking of more than one object. According to the third tracking technique, a tracking result has to be output after all the frames containing the target object are input in advance. Moreover, the third tracking technique is adapted to false positive (erroneous detection of an object which is not targeted for tracking), but is not adapted to interrupted tracking caused by false negative (not being able to detect an object which is target for tracking).

Moreover, the first tracking result managing method is a technique for processing the tracking of objects in a short time, and is not intended to improve the accuracy or reliability of a track processing result. According to the second tracking result managing method, one of the results of tracking persons is only output as an optimum tracking result. However, according to the second tracking result managing method, unsuccessful tracking attributed to the problem of tracking accuracy is recorded as an improper tracking result, and proportionate candidates cannot be recorded or an output result cannot be controlled depending on a result.

### BRIEF DESCRIPTION OF THE DRAWINGS

FIG. 1 is a diagram showing a system configuration example to be applied to embodiments;

FIG. 2 is a diagram showing a configuration example of a person tracking system as a moving object tracking system according to the first embodiment;

FIG. 3 is a flowchart for illustrating an example of processing for calculating a reliability of a tracking result;

FIG. 4 is a diagram for illustrating tracking results output from a face tracking unit;

FIG. 5 is a flowchart for illustrating an example of communication setting processing in a communication control unit;

FIG. 6 is a diagram showing an example of display in a display unit f a monitor device;

FIG. 7 is a diagram showing a configuration example of a person tracking system as a moving object tracking system according to the second embodiment;

FIG. 8 is a diagram showing an example of display in a display unit of a monitor unit according to the second embodiment;

FIG. 9 is a diagram showing a configuration example of a person tracking system as a moving object tracking system according to the third embodiment;

FIG. 10 is a diagram showing a configuration example of data that indicates face detection results stored in a face detection result storage unit;

FIG. 11 is a diagram showing an example of a graph created by a graph creating unit;

FIG. 12 is a graph showing an example of a probability of matching and a probability of mismatching between a face detected in an image and a face detected in another image that follows;

FIG. 13 is a graph conceptually showing the values of branch weights corresponding to the relation between the matching probability and the mismatching probability;

FIG. 14 is a diagram showing a configuration example of a person tracking system as a moving object tracking system according to the fourth embodiment;

FIG. 15 is a diagram for illustrating an example of processing in a scene selecting unit;

FIG. 16 shows an example of numerical values of the reliabilities of detection result rows;

FIG. 17 is a diagram showing an example of the number of frames in which tracking is successful and which serve as standards for reliability calculation;

FIG. 18 is a diagram showing an example of the tracking results of a moving object by tracking processing that uses a tracking parameter;

FIG. 19 is a flowchart schematically showing a processing procedure by a scene selecting unit;

FIG. 20 is a flowchart schematically showing a processing procedure by a parameter estimating unit; and

FIG. 21 is a flowchart for illustrating the flow of the overall processing.

### DETAILED DESCRIPTION

In general, according to one embodiment, a moving object tracking system includes an input unit, a detection unit, a creating unit, a weight calculating unit, a calculating unit, and an output unit. The input unit inputs time-series images captured by a camera. The detection unit detects all tracking target moving objects from each of the input images input by the input unit. The creating unit creates a combination of a path that links each moving object detected in a first image by the detection unit to each moving object detected in a second image following the first image, a path that links each moving object detected in the first image to an unsuccessful detection in the second image, and a path that links an unsuccessful detection in the first image to each moving object detected in the second image. The weight calculating unit calculates a weight for each path created by the creating unit. The calculating unit calculates a value for the combination of the paths to which the weights calculated by the weight calculating unit are allocated. The output unit outputs a tracking result based on the value for the combination of the paths calculated by the calculating unit.

Hereinafter, first, second, third, and fourth embodiments will be described in detail with reference to the drawings.

A system according to each embodiment is a moving object tracking system (moving object monitoring system) for detecting a moving object from images captured by a large number of cameras and tracking (monitoring) the detected moving object. In each embodiment, a person tracking system for tracking the movement of a person (moving object) is described as an example of a moving object tracking system. However, the person tracking system according to each of the later-described embodiments can also be used as a tracking system for tracking moving objects other than a person (e.g., a vehicle or an animal) by changing the processing for detecting the face of a person to detection processing suited to a moving object to be tracked.

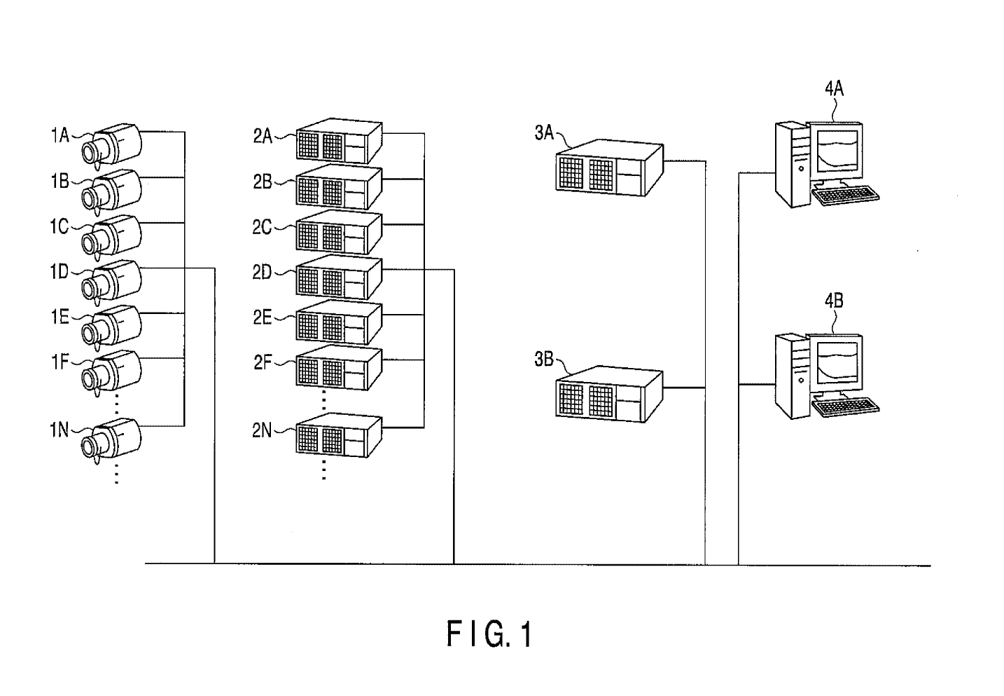

FIG. 1 is a diagram showing a system configuration example to be applied to each of the later-described embodiments.

The system shown in FIG. 1 comprises a large number of (e.g., 100 or more) cameras 1 (1A, . . . 1N, . . . ), a large number of client terminal devices (2A, . . . 2N, . . . ), servers 3 (3A and 3B), and monitoring devices (4A and 4B).

The system having the configuration shown in FIG. 1 processes a large number of pictures captured by the large number of cameras 1 (1A, . . . 1N, . . . ). It is assumed that there are also a large number of persons (faces of persons) as moving objects to be tracking targets (search targets) in the system shown in FIG. 1. The moving object tracking system shown in FIG. 1 is a person tracking system for extracting face images from a large number of pictures captured by the large number of cameras and tracking each of the face images. The person tracking system shown in FIG. 1 may collate (face collation) a tracking target face image with face images registered on a face image database. In this case, there are more than one face image database or a there is a large-scale face image database to register a large number of search target face images. The moving object tracking system in each embodiment displays processing results of a large number of pictures (tracking results or face collating results) on a monitor device visually monitored by an observer.

The person tracking system shown in FIG. 1 processes a large number of pictures captured by the large number of cameras. Thus, the person tracking system may perform the tracking processing and the face collating processing by more than one processing system comprising more than one server. As the moving object tracking system in each embodiment processes a large number of pictures captured by the large number of cameras, a large number of processing results (e.g., tracking results) may be obtained depending on the operating condition. For the observer to efficiently monitor, the moving object tracking system in each embodiment needs to efficiently display the processing results (tracking results) on the monitoring devices even when a large number of processing results are obtained in a short time. For example, the moving object tracking system in each embodiment displays the tracking results in descending order of reliability depending on the operating condition of the system, thereby preventing the observer from overlooking an important processing result, and reducing a burden on the observer.

In each of the embodiments described below, when faces of more than one person are contained in pictures (time-series images, or moving images comprising frames) obtained by the cameras, the person tracking system as the moving object tracking system tracks each of the persons (faces). Alternatively, the system described in each embodiment is a system for detecting, for example, a moving object (e.g., person or vehicle) from a large number of pictures collected by a large number of cameras, and recording the detection results (scenes) in a recording device together with the tracking results. The system described in each embodiment may otherwise be a monitor system for tracking a moving object (e.g., the face of a person) detected from an image captured by a camera, and collating the feature amount of the tracked moving object (the face of the subject) with dictionary data (the feature amount of the face of a registrant) previously registered on a database (face database) to identify the moving object, and then reporting the identification result of the moving object.

First, the first embodiment is described.

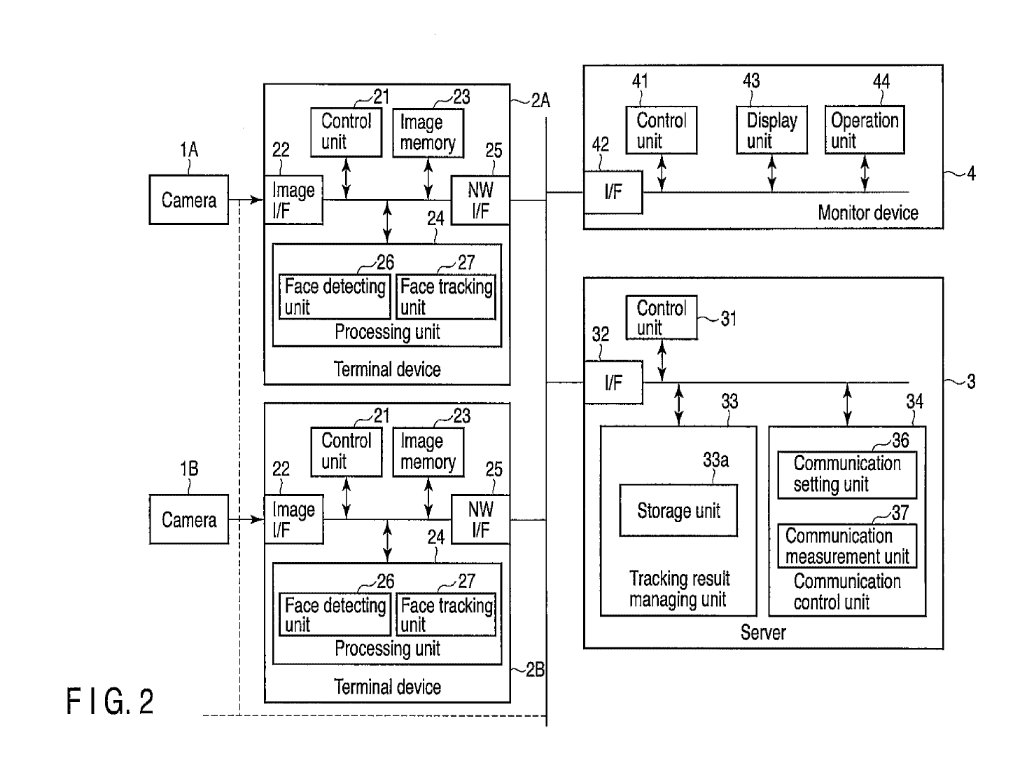

FIG. 2 is a diagram showing a hardware configuration example of a person tracking system as a moving object tracking system according to the first embodiment.

The person tracking system (moving object tracking system) described in the first embodiment tracks, as a detection target, the face of a person (moving object) detected from images captured by cameras, and records a tracking result in a recording device.

The person tracking system shown in FIG. 2 comprises cameras 1 (1A, 1B, . . . ), terminal devices 2 (2A, 2B, . . . ), a server 3, and a monitor device 4. Each of the terminal devices 2 and the server 3 are connected via a communication line 5. The server 3 and the monitor device 4 may be connected via the communication line 5 or may be locally connected.

Each of the cameras 1 photographs a monitor area allocated thereto. The terminal devices 2 process images captured by the cameras 1. The server 3 generally manages results of processing in the respective terminal devices 2. The monitor device 4 displays the processing results managed by the server 3. There may be more than one server 3 and more than one monitor device 4.

In the configuration example shown in FIG. 2, the cameras 1 (1A, 1B, . . . ) and the terminal devices 2 (2A, 2B, . . . ) are connected by communication wires designed for image transfer. For example, the cameras 1 and the terminal devices 2 may be connected by camera signal cables of, for example, NTSC. However, the cameras 1 and the terminal devices 2 may be connected via the communication line (network) 5 as in the configuration shown in FIG. 1.

Each of the terminal devices 2 (2A, 2B) comprises a control unit 21, an image interface 22, an image memory 23, a processing unit 24, and a network interface 25.

The control unit 21 controls the terminal device 2. The control unit 21 comprises, for example, a processor which operates in accordance with a program, and a memory in which the program to be executed by the processor is stored. That is, the processor executes the program in the memory so that the control unit 21 achieves various kinds of processing.

The image interface 22 is an interface for inputting time-series images (e.g., moving images in predetermined frame units) from the cameras 1. When the camera 1 and the terminal device 2 are connected via the communication line 5, the image interface 22 may be a network interface. The image interface 22 also functions to digitize (A/D converts) the image input from the camera 1 and supply the digitized images to the processing unit 24 or the image memory 23. For example, the image captured by the camera and acquired by the image interface 22 is stored in the image memory 23.

The processing unit 24 processes the acquired image. For example, the processing unit 24 comprises a processor which operates in accordance with a program, and a memory in which the program to be executed by the processor is stored. As processing functions, the processing unit 24 comprises a face detecting unit 26 which detects a region of a moving object (the face of a person) if any, and a face tracking unit 27 which tracks the identical moving object to match the movements between the input images. These functions of the processing unit 24 may be obtained as functions of the control unit 21. Moreover, the face tracking unit 27 may be provided in the server 3 that can communicate with the terminal device 2.

The network interface 25 is an interface for communicating via the communication line (network). Each of the terminal devices 2 performs data communication with the server 3 via the network interface 25.

The server 3 comprises a control unit 31, a network interface 32, a tracking result managing unit 33, and a communication control unit 34. The monitor device 4 comprises a control unit 41, a network interface 42, a display unit 43, and an operation unit 44.

The control unit 31 controls the whole server 3. The control unit 31 comprises, for example, a processor which operates in accordance with a program, and a memory in which the program to be executed by the processor is stored. That is, the processor executes the program stored in the memory so that the control unit 31 achieves various kinds of processing. For example, the processor may execute the program in the control unit 31 of the server 3 to obtain a processing function similar to the face tracking unit 27 of the terminal device 2.

The network interface 32 is an interface for communicating with each of the terminal devices 2 and the monitor device 4 via the communication line 5. The tracking result managing unit 33 comprises a storage unit 33a, and a control unit for controlling the storage unit. The tracking result managing unit 33 stores, in the storage unit 33a, a tracking result of the moving object (the face of the person) acquired from each of the terminal devices 2. Not only information indicating the tracking results but also images captured by the cameras 1 are stored in the storage unit 33a of the tracking result managing unit 33.

The communication control unit 34 controls communications. For example, the communication control unit 34 adjusts a communication with each of the terminal devices 2. The communication control unit 34 comprises a communication measurement unit 37 and a communication setting unit 36. The communication measurement unit 37 finds a communication load such as a communication amount on the basis of the number of cameras connected to each of the terminal devices 2 or the amount of information such as the tracking result supplied from each of the terminal devices 2. The communication setting unit 36 sets the parameter of information to be output as a tracking result to each of the terminal devices 2 on the basis of the communication amount measured by the communication measurement unit 37.

The control unit 41 controls the whole monitor device 4. The network interface 42 is an interface for communicating via the communication line 5. The display unit 43 displays, for example, the tracking result supplied from the server 3 and the images captured by the cameras 1. The operation unit 44 comprises, for example, a keyboard or mouse to be operated by an operator.

Now, the configuration and processing in each unit of the system shown in FIG. 2 are described.

Each of the cameras 1 takes images of the monitor area. In the configuration example shown in FIG. 2, each of the cameras 1 takes time-series images such as moving images. Each of the cameras 1 takes images including images of the face of a person present in the monitor area as a moving image targeted for tracking. The image captured by the camera 1 is A/D converted via the image interface 22 of the terminal device 2, and sent to the face detecting unit 26 in the processing unit 24 as digitized image information. The image interface 22 may input images from devices other than the camera 1. For example, the image interface 22 may load image information such as moving images recorded in a recording medium to input time-series images.

The face detecting unit 26 performs processing to detect all faces (one or more faces) present in the input images. The following techniques can be applied as specific processing method for detecting faces. First, a prepared template is moved in an image to find a correlation value so that a position providing the highest correlation value is detected as the region of the face image. Otherwise, faces can be detected by a face extraction method that uses an eigenspace method or a subspace method. The accuracy of the face detection can be increased by detecting the position of a facial part such as an eye or a nose from the detected region of the face image. To such a face detection method, it is possible to apply a technique described in, for example, a document (Kazuhiro Hukui and Osamu Yamaguchi: “Facial Feature Point Extraction Method Based on Combination of Shape Extraction and Pattern Matching”, the journal of the Institute of Electronics, Information and Communication Engineers (D), vol. J80-D-II, No. 8, pp. 2170-2177 (1997). For the above-mentioned eye or nose detection and the detection of a mouth region, it is possible to use a technique according to a document (Mayumi Yuasa and Akiko Nakashima: “Digital Make System based on High-Precision Facial Feature Point Detection”, 10th Image Sensing Symposium Proceedings, pp. 219-224 (2004). Both of the techniques acquire information that can be dealt with as two-dimensionally arranged images and detect a face feature region from the information.

In the above-described processing, in order to only extract one face feature from one image, it is possible to find values of the correlation of all the images with the template, and output a position and a size that maximize the values. In order to extract more than one face feature, it is possible to find a local maximum value of a correlation value of the whole image, narrow down face candidate positions in consideration of overlap in one image, and finally find more than one face feature in consideration of the relation (time shift) with sequentially input past images.

The face tracking unit 27 performs processing to track the face of a person as a moving object. For example, a technique described in detail in the later third embodiment can be applied to the face tracking unit 27. The face tracking unit 27 integrates and optimally matches information such as the coordinates or size of the face of the person detected from the input images, and integrally manages and outputs, as a tracking result, the result of the matching of the identical persons throughout frames.

There is a possibility that the face tracking unit 27 may not determine a single result (tracking result) of the matching of persons in the images. For example, when there is more than one person moving around, there may be complicated movements such as crossing of the persons, so that the face tracking unit 27 obtains more than one tracking result. In this case, the face tracking unit 27 can not only output a result having the strongest likelihood in the matching as a first candidate but also manage the proportionate matching results.

The face tracking unit 27 also functions to calculate a reliability of a tracking result. The face tracking unit 27 can select a tracking result to be output, on the basis of the reliability. The reliability is determined in consideration of information such as the number of obtained frames and the number of detected faces. For example, the face tracking unit 27 can set a numerical value of reliability on the basis of the number of frames in which tracking is successful. In this case, the face tracking unit 27 can decrease the reliability of a tracking result indicating that only a small number of frames can be tracked.

The face tracking unit 27 may otherwise combine more than one standard to calculate a reliability. For example, when the similarity of a detected face image is available, the face tracking unit 27 can set the reliability of a tracking result showing a small number of frames in which tracking is successful but showing a high average similarity of face images to be higher than the reliability of a tracking result showing a large number of frames in which tracking is successful but showing a low average similarity of face images.

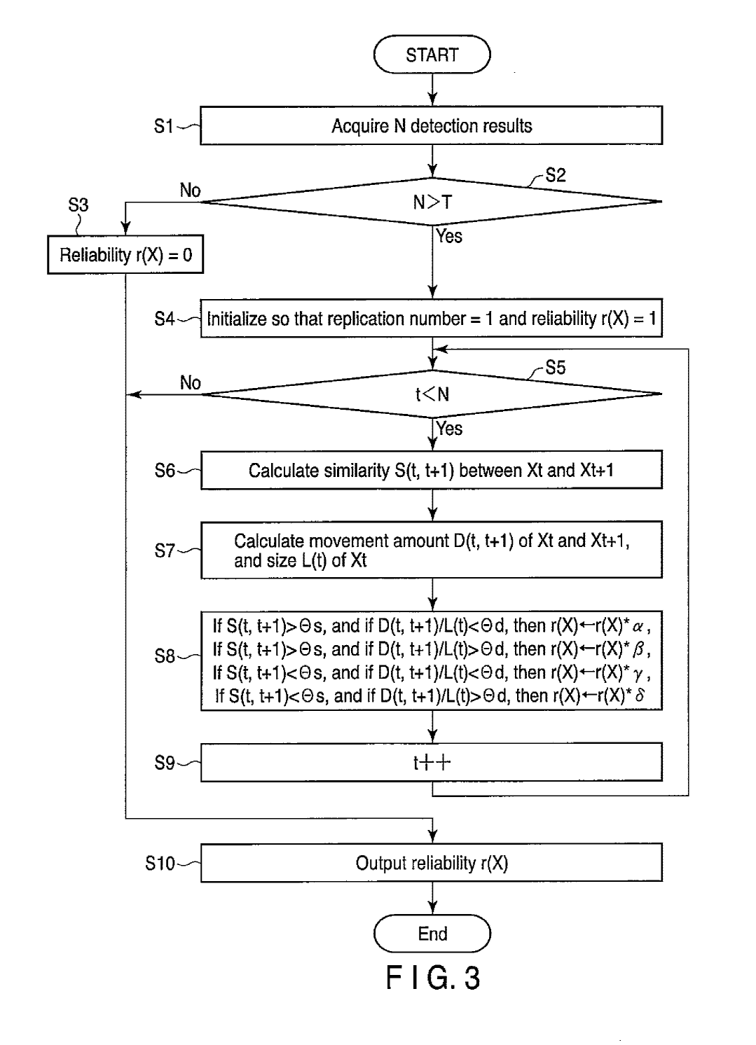

FIG. 3 is a flowchart for illustrating an example of the processing for calculating a reliability of a tracking result.

Note that in FIG. 3, inputs as tracking results are N time-series face detection results (an image and a position the image) X1, . . . , X2, and a threshold θs, a threshold θd, and reliability parameters α, β, γ, δ (α+β+γ+δ)=1, α, β, γ, δ≥0) are set as constant numbers.

First, suppose that the face tracking unit 27 has acquired N time-series face detection results (X1, . . . , Xn) as face detection results (step S1). The face tracking unit 27 then judges whether the number N of the face detection results is greater than a predetermined number T (e.g., one) (step S2). When the number of the face detection results N is equal to or less than the predetermined number T (step S2, NO), the face tracking unit 27 sets the reliability to 0 (step S3). When judging that the number of the face detection results N is greater than the predetermined number T (step S2, YES), the face tracking unit 27 initializes a replication number (variable) t and a reliability r(X) (step S4). In the example shown in FIG. 3, the face tracking unit 27 sets the initial value of the replication number t to 1, and sets the reliability r(X) to 1.

When the replication number (variable) t and the reliability r(X) are initialized, the face tracking unit 27 ascertains that the replication number t is smaller than the number of the face detection results N (step S5). That is, when t<N (step S5, YES), the face tracking unit 27 calculates a similarity S(t, t+1) between Xt and Xt+1 (step S6). Further, the face tracking unit 27 calculates a movement amount D(t, t+1) of Xt and Xt+1, and a size L(t) of Xt (step S7).

In accordance with the similarity S (t, t+1), the movement amount D(t, t+1), and the L(t), the face tracking unit 27 calculates (updates) the reliability r(X) in the following manner.

If S(t,t+1)>θs, and if D(t,t+1)/L(t)<θd, then r(X)←r(X)*α,

If S(t,t+1)>θs, and if D(t,t+1)/L(t)>θd, then r(X)←r(X)*β,

If S(t,t+1)<θs, and if D(t,t+1)/L(t)<θd, then r(X)←r(X)*γ,

If S(t,t+1)<θs, and if D(t,t+1)/L(t)>θd, then r(X)←r(X)*δ.

After calculating (updating) the reliability r(X), the face tracking unit 27 increments the replication number t (t=t+1) (step S9), and returns to step S5. For the individual face detection results (scenes) X1, . . . , Xn, reliabilities corresponding to the similarity S(t, t+1), the movement amount D(t, t+1), and the L(t) may also be calculated. However, the reliability of the whole tracking result is calculated here.

By repetitively performing the processing in steps S5 to S9, the face tracking unit 27 calculates reliabilities of the tracking results comprising the acquired N time-series face detection results. That is, when judging in step S5 that t is not less than N (step S2, NO), the face tracking unit 27 outputs the calculated reliability r(X) as the reliability of the tracking result for the N time-series face detection results (step S10).

In the processing example described above, the tracking result is a time series of face detection results. Specifically, each of the face detection results is made up of a face image and information on the position in the image. The reliability is a numerical value of 0 or more and 1 or less. The reliability is set so that the similarity may be high when faces between adjacent frames are compared and so that the reliability of the tracking result may be high when the movement amount is not great. For example, when person detection results are mixed, the similarity is decreased if a similar comparison is made. In the reliability calculation processing described above, the face tracking unit 27 determines the degree of similarity and the amount of movement by comparing with preset thresholds. For example, when a tracking result includes a set of images that are low in similarity and great in the movement amount, the face tracking unit 27 multiplies the reliability by the parameter 8 to decrease the value of the reliability.

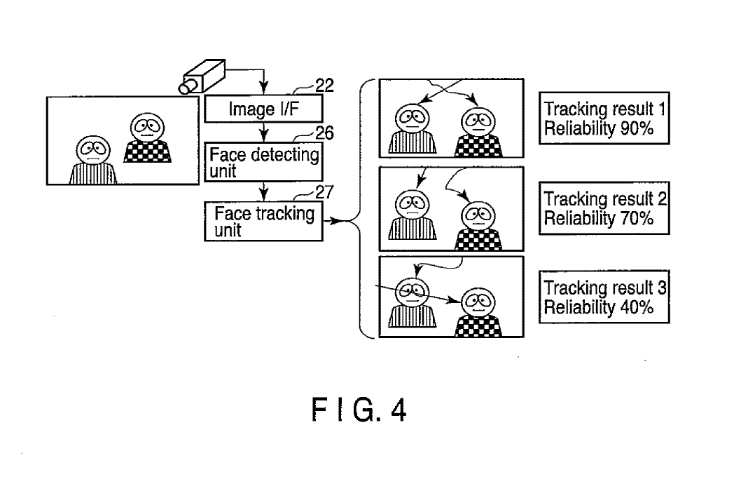

FIG. 4 is a diagram for illustrating tracking results output from the face tracking unit 27.

As shown in FIG. 4, the face tracking unit 27 can output not only one tracking result but also more than one tracking result (tracking candidate). The face tracking unit 27 has a function that enables dynamic setting of which tracking result to be output. For example, the face tracking unit 27 judges which tracking result to be output in accordance with a reference value set by the communication setting unit of the server. The face tracking unit 27 calculates a reliability of each tracking result candidates, and outputs a tracking result showing a reliability higher than the reference value set by the communication setting unit 36. When the number (e.g., N) of tracking result candidates to be output is set by the communication setting unit 36, the face tracking unit 27 can be adapted to output tracking result candidates up to the set number (higher tracking result candidates up to N) together with the reliabilities.

When a “reliability of 70% or more” is set for the tracking result shown in FIG. 4, the face tracking unit 27 outputs a tracking result 1 and a tracking result 2 that are equal to or more than a reliability of 70%. When a set value is set to “up to one high result”, the face tracking unit 27 only transmits the tracking result 1 showing the highest reliability. Data output as the tracking result may be settable by the communication setting unit 36 or may be selectable by the operator using the operation unit.

For example, an input image and a tracking result may be output as data for one tracking result candidate. As data for one tracking result candidate, an image (face image) which is a cutout image of a part located in the vicinity of the detected moving object (face) may be output in addition to the input image and the tracking result. In addition to such information, all the images that can be regarded as containing the identical moving object (face) and thus matched with one another (a predetermined reference number of images selected from the matched images) may be selectable in advance. In order to set these parameters (to set data to be output as one tracking result candidate), parameters designated by the operation unit 44 of the monitor device 4 may be set in the face tracking unit 27.

The tracking result managing unit 33 manages, on the server 3, the tracking results acquired from the terminal devices 2. The tracking result managing unit 33 of the server 3 acquires the above-described data for the tracking result candidate from each of the terminal devices 2, and records the data for the tracking result candidate acquired from the terminal device 2 in the storage unit 33a, and thus manages the data.

The tracking result managing unit 33 may collectively record the pictures captured by the cameras 1 as moving images in the storage unit 33a. Alternatively, only when a face is detected or only when a tracking result is obtained, the tracking result managing unit 33 may record pictures of this portion as moving images in the storage unit 33a. Otherwise, the tracking result managing unit 33 may only record the detected face region or person region in the storage unit 33a, or may only record, in the storage unit 33a, the best images judged to be most easily seen among tracked frames. In the present system, the tracking result managing unit 33 may receive more than one tracking result. Thus, the tracking result managing unit 33 may manage and store, in the storage unit 33a, the place of the moving object (person) in each frame, identification ID indicating the identity of the moving object, and the reliability of the tracking result, in such a manner as to match with the moving images captured by the cameras 1.

The communication setting unit 36 sets parameters for adjusting the amount of data as the tracking result acquired by the tracking result managing unit 33 from each terminal device. The communication setting unit 36 can set one or both of, for example, “a threshold of the reliability of the tracking result” or “the maximum number of tracking result candidates”. Once these parameters are set, the communication setting unit 36 can set each terminal device to transmit a tracking result having a reliability equal to or more than the set threshold when more than one tracking result candidate is obtained as a result of the tracking processing. When there is more than one tracking result candidate as a result of the tracking processing, the communication setting unit 36 can also set, for each terminal device, the number of candidates to be transmitted in descending order of reliability.

Furthermore, the communication setting unit 36 may set parameters under the instruction of the operator, or may dynamically set parameters on the basis of the communication load (e.g., communication amount) measured by the communication measurement unit 37. In the former case, the operator may use the operation unit to set parameters in accordance with an input value.

The communication measurement unit 37 monitors, for example, data amounts sent from the terminal devices 2 and thereby measures the state of the communication load. In accordance with the communication load measured by the communication measurement unit 37, the communication setting unit 36 dynamically changes the parameter for controlling the tracking result to be output to each of the terminal devices 2. For example, the communication measurement unit 37 measures the volume of moving images sent within a given period of time, or the amount of tracking results (communication amount). Thus, in accordance with the communication amount measured by the communication measurement unit 37, the communication setting unit 36 performs setting to change the output standard of the tracking result for each of the terminal devices 2. That is, in accordance with the communication amount measured by the communication measurement unit 37, the communication setting unit 36 changes the reference value for the reliability of the face tracking result output by each of the terminal devices, or adjusts the maximum number (the number N set to allow high N results to be sent) of transmitted tracking result candidates.

That is, when the communication load is high, data (data for the transmitted tracking result candidates) acquired from each of the terminal devices 2 has to be minimized in the whole system. In such a situation, the present system can be adapted to only output highly reliable tracking results or reduce the number of output tracking result candidates in accordance with the measurement result by the communication measurement unit 37.

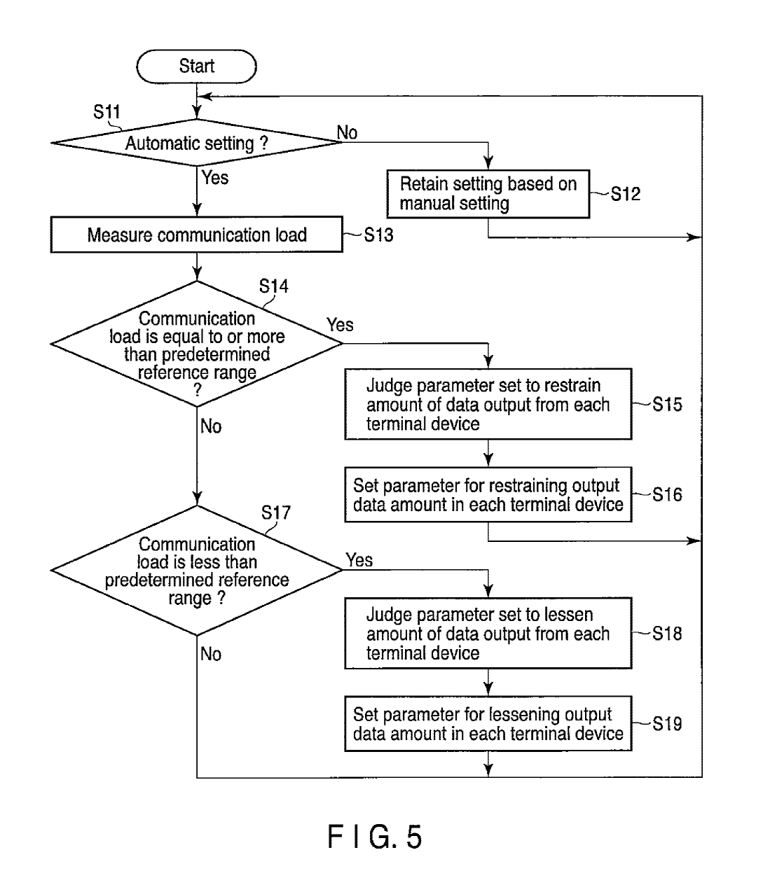

FIG. 5 is a flowchart for illustrating an example of communication setting processing in the communication control unit 34.

That is, in the communication control unit 34, the communication setting unit 36 judges whether the communication setting of each of the terminal devices 2 is automatic setting or manual setting by the operator (step S11). When the operator has designated the contents of the communication setting of each of the terminal devices 2 (step S11, NO), the communication setting unit 36 determines parameters for the communication setting of each of the terminal devices 2 in accordance with the contents designated by the operator, and sets the parameters in each of the terminal devices 2. That is, when the operator manually designates the contents of the communication setting, the communication setting unit 36 performs the communication setting in accordance with the designated contents regardless of the communication load measured by the communication measurement unit 37 (step S12).

When the communication setting of each of the terminal devices 2 is automatic setting (step S11, YES), the communication measurement unit 37 measures the communication load in the server 3 attributed to the amount of data supplied from each of the terminal devices 2 (step S13). The communication setting unit 36 judges whether the communication load measured by the communication measurement unit 37 is equal to or more than a predetermined reference range (i.e., whether the communication state is a high-load communication state) (step S14).

When the communication load measured by the communication measurement unit 37 is judged to be equal to or more than the predetermined reference range (step S14, YES), the communication setting unit 36 judges a parameter for a communication setting that restrains the amount of data output from each of the terminal devices in order to lessen the communication load (step S15).

For example, in the example described above, to lessen the communication load, it is possible to provide a setting that raises the threshold for the reliability of a tracking result candidate to be output, or a setting that reduces the set maximum number of output tracking result candidates. When the parameter for lessening the communication load (parameter for restraining output data from the terminal devices) is determined, the communication setting unit 36 sets the determined parameter in each of the terminal devices 2 (step S16). Thus, the amount of data output from each of the terminal devices 2 is reduced, so that the communication load can be reduced in the server 3.

When the communication load measured by the communication measurement unit 37 is judged to be less than the predetermined reference range (step S17, YES), more data can be acquired from each of the terminal devices, so that the communication setting unit 36 judges a parameter for a communication setting that lessen the amount of data output from each of the terminal devices (step S18).

For example, in the example described above, it is possible to provide a setting to drop the threshold for the reliability of a tracking result candidate to be output, or a setting to increase the set maximum number of output tracking result candidates. When the parameter expected to increase the amount of supplied data (parameter for lessening the data output from the terminal devices) is determined, the communication setting unit 36 sets the determined parameter in each of the terminal devices 2 (step S19). Thus, the amount of data output from each of the terminal devices 2 is increased, so that more data is obtained in the server 3.

According to the communication setting processing described above, in the automatic setting, the server can adjust the amount of data from each of the terminal devices depending on the communication load.

The monitor device 4 is a user interface comprising the display unit 43 for displaying the tracking results managed by the tracking result managing unit 33 and images corresponding to the tracking results, and the operation unit 44 for receiving the input from the operator. For example, the monitor device 4 can comprise a PC equipped with a display section and a keyboard or a pointing device, or a display device having a touch panel. That is, the monitor device 4 displays the tracking results managed by the tracking result managing unit 33 and images corresponding to the tracking results in response to a request from the operator.

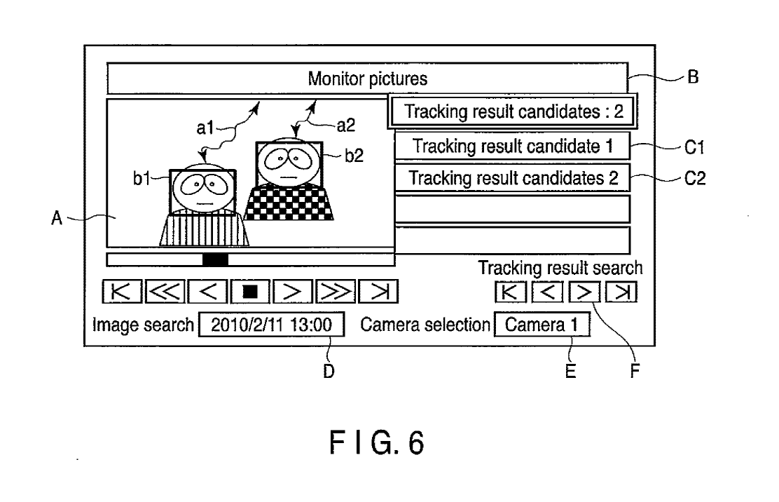

FIG. 6 is a diagram showing an example of display in the display unit 43 of the monitor device 4. As shown in the display example of FIG. 6, the monitor device 4 has a function of displaying moving images for a desired date and time or a desired place designated by the operator in accordance with a menu displayed on the display unit 43. As shown in FIG. 6, when there is a tracking result at the predetermined time, the monitor device 4 displays, on the display unit 43, a screen A of a captured picture including the tracking result.

When there is more than one tracking result candidate, the monitor device 4 displays, in a guide screen B, the face that there is more than one tracking result candidate, and displays, as a list, icons C1 and C2 for the operator to select the tracking result candidates. If the operator selects the icon of a tracking result candidate, tracking may be performed in accordance with the tracking result candidate of the selected icon. Moreover, when the operator selects the icon of a tracking result candidate, a tracking result corresponding to the icon selected by the operator is then displayed for the tracking result for this time.

In the example shown in FIG. 6, the operator selects a seek bar or various operation buttons provided immediately under the screen A for captured pictures, such that images can be reproduced, moved back or a picture at a given time can be displayed. Moreover, in the example shown in FIG. 6, there are also provided a selecting section E for a camera targeted for display, and an entry section D for a time targeted for a search. In the screen A for captured pictures, lines a1 and a2 indicating tracking results (tracks) for the faces of persons, and frames b1 and b2 indicating detection results of the faces of persons are also displayed as tracking results and information indicating face detection results.

In the example shown in FIG. 6, a “tracking start time” or a “tracking end time” for a tracking result can be designed as key information for a picture search. As the key information for a picture search, information on the place where a picture has been captured that is included in a tracking result (to search the picture for a person passing the designed place) can also be designated. In the example shown in FIG. 6, a button F for searching for a tracking result is also provided. For example, in the example shown in FIG. 6, the button F can be designated to jump to a tracking result in which the person is detected next.

According to the display screen shown in FIG. 6, a given tracking result can be easily found from the pictures managed by the tracking result managing unit 33. Thus, even if a tracking result is complicated and easily causes an error, an interface can be provided such that a correction can be made through the visual confirmation by the operator or a correct tracking result may be selected.

The person tracking system according to the first embodiment described above can be applied to a moving object tracking system which detects and tracks a moving object in a monitored picture and records the image of the moving object. In the moving object tracking system according to the first embodiment described above, the reliability of tracking processing for a moving object is found. One tracking result is output for a highly reliable tracking result. For a low reliability, pictures can be recorded as tracking result candidates. Consequently, in the moving object tracking system described above, a recorded picture can be searched for afterwards, and at the same time, a tracking result or a tracking result candidate can be displayed and selected by the operator.

Now, the second embodiment is described.

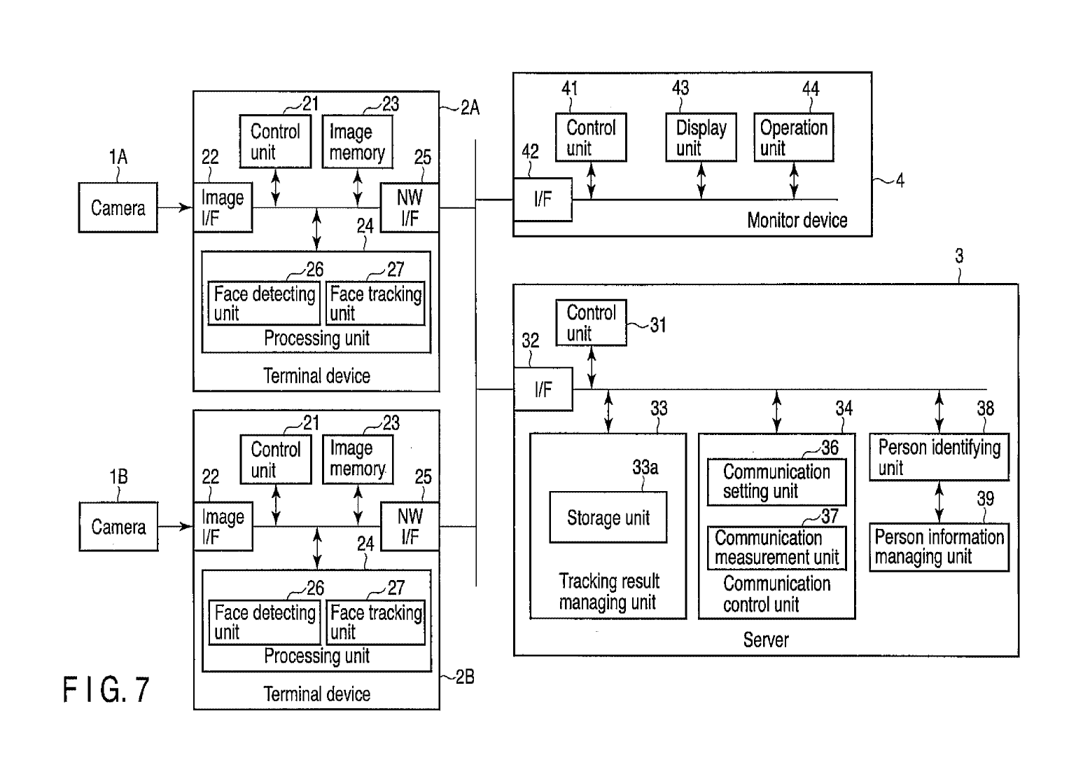

FIG. 7 is a diagram showing a hardware configuration example of a person tracking system as a moving object tracking system according to the second embodiment.

The system according to the second embodiment tracks, as a detection target (moving object), the face of a person photographed by monitor cameras, recognizes whether the tracked person corresponds to previously registered persons, and records the recognition result in a recording device together with the tracking result. The person tracking system according to the second embodiment shown in FIG. 7 has a configuration shown in FIG. 2 to which a person identifying unit 38 and a person information managing unit 39 are added. Therefore, components similar to those in the person tracking system shown in FIG. 2 are provided with the same signs and are not described in detail.

In the configuration example of the person tracking system shown in FIG. 7, the person identifying unit 38 identifies (recognizes) a person as a moving object. The person information managing unit 39 previously stores and manages feature information regarding a face image as feature information for a person to be identified. That is, the person identifying unit 38 compares the feature information for an image of a face as a moving object detected from an input image with the feature information for face images of persons registered in the person information managing unit 39, thereby identifying the person as a moving object detected from the input image.

In the person tracking system according to the present embodiment, the person identifying unit 38 calculates the feature information for identifying a person by using image groups that are judged to show the identical person on the basis of a face-containing image managed by the tracking result managing unit 33 and a tracking result (coordinate information) for the person (face). This feature information is calculated, for example, in the following manner. First, a piece such an eye, a nose or a mouth is detected in a face image. A face region is cut into a shape of a given size in accordance with the position of the detected piece. Thickness information for the cut portion is used as a feature amount. For example, a thickness value of a region of m pixels×n pixels region is directly used as feature vectors comprising m×n-dimensional information. The feature vectors are normalized by a method called a simple similarity method so that a vector and the length of the vector may respectively be is, and an inner product is calculated to find a similarity degree that indicates the similarity between the feature vectors. Feature extraction is thus completed in the case of processing that uses one image to derive a recognition result.

However, more accurate recognizing processing can be performed by a moving-imaged-based calculation that uses sequential images. Thus, this technique is considered in the description of the present embodiment. That is, an image comprising m×n pixels is cut out of sequentially obtained input images as in the case of the feature extraction means. A correlation matrix of feature vectors is found from the data, and an orthonormal vectors by KL expansion is found. Thereby, a subspace representing the features of a face obtained from the sequential images is calculated.

In order to calculate the subspace, a correlation matrix (or covariance matrix) of feature vectors is found, and an orthonormal vectors (eigenvectors) by the KL expansion of the matrix is found. The subspace is represented by selecting k eigenvectors corresponding to eigenvalues in descending order of eigenvalue and using the set of the eigenvectors. In the present embodiment, a correlation matrix Cd is found from feature vectors and diagonalized to a correlation matrix Cd=ϕdΛdϕdT, thereby finding a matrix ϕ of the eigenvectors. This information serves as the subspace that represents the features of the face of the person currently targeted for recognition. The above-described processing for calculating the feature information may be performed in the person identifying unit 38, but may otherwise be performed in the face tracking unit 27 on the camera side.

Although more than one frame is used to calculate the feature information according to the technique in the embodiment described above, it is also possible to use a recognizing method which selects one or more frames that seem to be most suitable for the recognizing processing from frames obtained by tracking a person. In this case, a frame selecting method using any index may be used as long as the index shows the change of face conditions; for example, the directions of a face are found and a nearly full-faced frame is preferentially selected, or a frame showing the face in a greatest size is selected.

Furthermore, whether a previously registered person is present in a current image can be judged by comparing the similarity between an input subspace obtained by the feature extraction means and previously registered one or more subspaces. A subspace method or a multiple similarity method may be used as a calculation method for finding the similarity between subspaces. For the recognizing method in the present embodiment, it is possible to use a mutual subspace method described in, for example, a document (Kenichi Maeda and Sadakazu Watanabe: “Pattern Matching Method with Local Structure”, the journal of the Institute of Electronics, Information and Communication Engineers (D), vol. J68-D, No. 3, pp. 345-352 (1985)). According to this method, both recognition data in prestored registered information and input data are represented as subspaces calculated from images, and an “angle” between the two subspaces is defined as a similarity. The subspace input here is referred to as an input means subspace. A correlation matrix Cin is likewise found for an input data row, and diagonalized to Cin=ϕinΛinϕinT, thereby finding an eigenvector ϕin. An inter-subspace similarity (0.0 to 1.0) between the two subspaces represented by ϕin and ϕd is found, and used as a similarity for the recognition.

When there is more than one face in an image, similarities to the feature information for the face images registered in the person information managing unit 39 are calculated in order in a round-robin manner, such that results for all the persons can be obtained. For example, if there are dictionaries for Y persons when X persons are walking, results for all of the X persons can be output by performing X×Y similarity calculations. When a recognition result cannot be output by calculation results in which m images are input (when the person is not judged to be any of the registered persons and a next frame is acquired to perform a calculation), the correlation matrix input to the above-mentioned subspace corresponding to one frame is added to the sum of correlation matrixes created by past frames, and the calculation of an eigenvector and the creation of a subspace are again conducted, such that the subspace on the input side can be updated. That is, to sequentially take and collate images of the face of a walker, images are acquired one by one to update the subspace simultaneously with a collation calculation, thereby enabling a calculation gradually increasing in accuracy.

When tracking results of the same scene are managed in the tracking result managing unit 33, more than one person identification result can be calculated. Whether to perform the calculation may be directed by the operator using the operation unit 44 of the monitor device 4. Alternatively, results may be always obtained, and necessary information may be selectively output in response to an instruction from the operator.

The person information managing unit 39 manages, person by person, the feature information obtained from an input image to recognize (identify) a person. Here, the person information managing unit 39 manages, as a database, the feature information created by the processing described in connection with the person identifying unit 38. The present embodiment assumes the same m×n feature vectors after feature extraction as the feature information obtained from an input image. However, face images before feature extraction may be used, and a subspace to be used or a correlation matrix immediately before KL expansion may be used. These are stored by using, as a key, a personal ID number for personal identification. Here, one piece of face feature information may be registered for one person, or feature information for more than one face may be retained to be available to recognition simultaneously with switching depending on the situation.

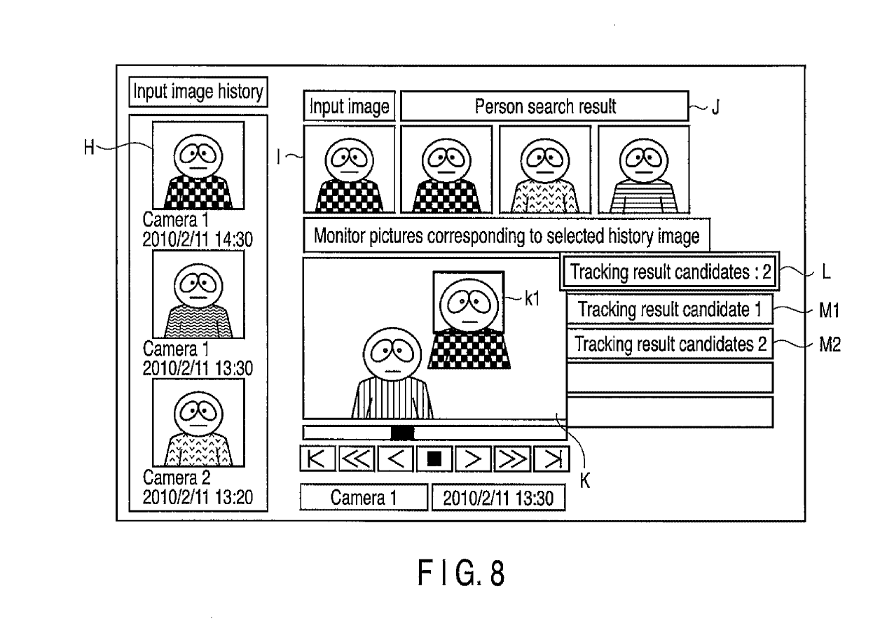

Similarly to the monitor device 4 described in the first embodiment, the monitor device 4 displays the tracking results managed by the tracking result managing unit 33 and images corresponding to the tracking results. FIG. 8 is a diagram showing an example of display in the display unit 43 of the monitor device 4 according to the second embodiment. In the processing according to the second embodiment, not only a person detected from image captured by camera is tracked but also the detected person is recognized. Thus, according to the second embodiment, the monitor device 4 displays a screen that shows identification results of detected persons in addition to the tracking results and the images corresponding to the tracking results, as shown in FIG. 8.

That is, in the example shown in FIG. 8, the display unit 43 displays an input image history display section H for sequentially displaying images of representative frames in pictures captured by the cameras. In the example shown in FIG. 8, representative images of the face of a person as a moving object detected from images captured by the cameras 1 are displayed in the history display section H in such a manner as to match with photography places and times. The face image of the person displayed in the history display section H can be selected by the operator using the operation unit 44.

If a face image of one person displayed in the history display section H is selected, the selected input image is displayed in input image section I that shows the face image of the person targeted for identification. The input image sections I are displayed side by side in a person search result section J. A list of registered face images similar to the face images displayed in the input image sections I is displayed in the search result section J. The face images displayed in the search result section J are registered face images similar to the face images displayed in the input image sections I among face images of persons registered in the person information managing unit 39 in advance.

Although the list of face images to be candidates for the person corresponding to the input image is shown in the example shown in FIG. 8, the images can be displayed in different colors or an alarm sound, for example, can be generated when the similarity of a candidate obtained as a, search result is equal to or more than a predetermined threshold. This makes it possible to inform that a given person is detected from the images captured by the cameras 1.

Furthermore, in the example shown in FIG. 8, when one of the input face images displayed in the input image history display section H is selected, pictures captured by the cameras 1 from which the selected face image (input image) is detected are displayed in a picture display section K at the same time. As a result, in the example shown in FIG. 8, it is possible to easily check not only the face image of the person but also the behavior of the person at the photography place or the conditions of the surrounding. That is, when one input image is selected from the history display section H, moving images including the photography time of the selected input image are displayed in the picture display section K, and at the same time, a frame K1 that indicates a candidate for the person corresponding to the input image is displayed, as shown in FIG. B. Here, all the pictures captured by the cameras 1 are supplied to the server 3 from the terminal devices 2, and stored in, for example, the storage unit 33a.

When there is more than one tracking result, the fact that there is more than one tracking result candidate is displayed in a guide screen L, and a list of icons M1 and M2 for the operator to select the tracking result candidates is displayed. If the operator selects any one of the icons M1 and M2, the contents of the face images and moving images displayed in the above-mentioned person search section may be set to be updated in accordance with the tracking result corresponding to the selected icon. The reason is that the image group used for a search may vary with varying tracking results. Even when the tracking result may change, the operator can visually check tracking result candidates in the display example shown in FIG. 8.

The pictures managed in the tracking result managing unit can be searched for similarly to the pictures described in the first embodiment.

As described above, the person tracking system according to the second embodiment can be applied as a moving object tracking system for detecting and tracking a moving object in observation pictures captured by the cameras and comparing the tracked moving object with previously registered information and thereby identifying the moving object. In the moving object tracking system according to the second embodiment, a reliability of tracking processing for a moving object is found. For a highly reliable tracking result, identifying processing for the tracked moving object is performed by one tracking result. For a low reliability, identifying processing for the tracked moving object is performed by more than one tracking result.

Thus, in the moving object tracking system according to the second embodiment, a person can be identified from an image group based on tracking result candidates when an erroneous tracking result is easily made, for example, when the reliability is low. Accordingly, information (a moving object tracking result and a moving object identification result) regarding the tracked moving object can be correctly displayed in an easily recognizable manner to the manager or operator of the system at the place where the pictures are captured.

Now, the third embodiment is described.

The third embodiment includes processing that can be applied to the processing in the face tracking unit 27 of the person tracking system described above in the first and second embodiments.

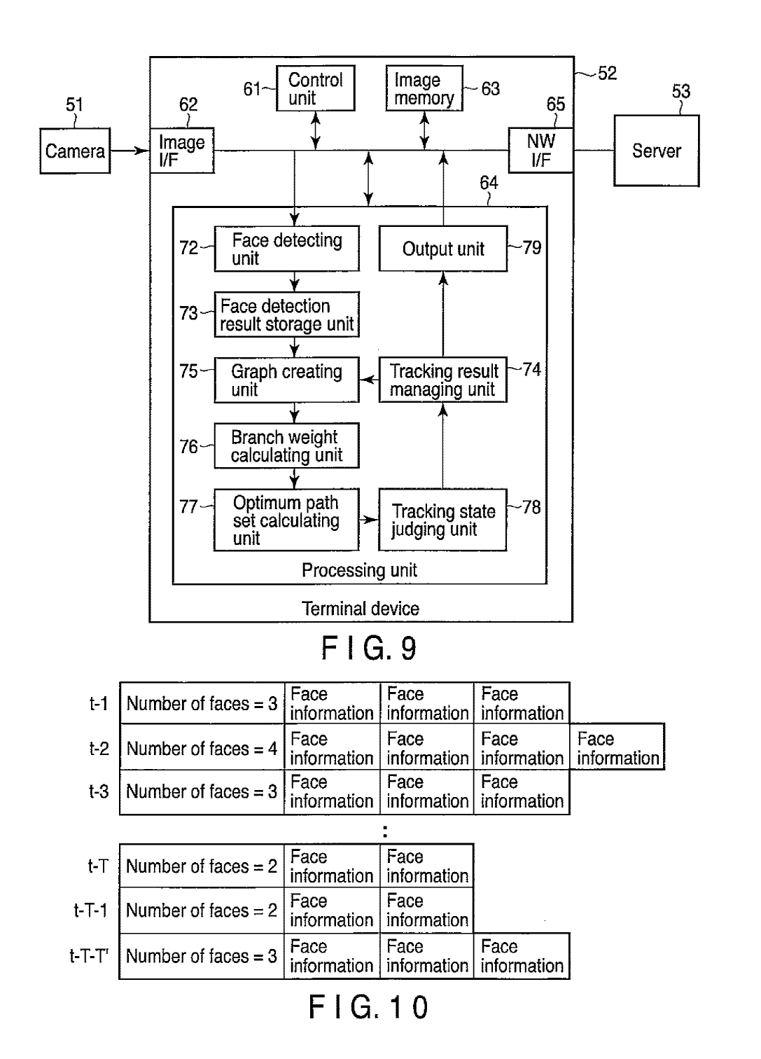

FIG. 9 is a diagram showing a configuration example of a person tracking system according to the third embodiment. In the configuration example shown in FIG. 9, the person tracking system comprises hardware such as a camera 51, a terminal device 52, and a server 53. The camera 51 takes a picture of a monitor area. The terminal device 52 is a client device for performing tracking processing. The server 53 is a device for managing and displaying tracking results. The terminal device 52 and the server 53 are connected by a network. The camera 51 and the terminal device 52 may be connected by a network cable or by a camera signal cable of, for example, NTSC.

As shown in FIG. 9, the terminal device 52 comprises a control unit 61, an image interface 62, an image memory 63, a processing unit 64, and a network interface 65. The control unit 61 controls the terminal devices 2. The control unit 61 comprises, for example, a processor which operates in accordance with a program, and a memory in which the program to be executed by the processor is stored. The image interface 62 is an interface for acquiring an image including a moving object (the face of a person) from the camera 51. The image acquired from the camera 51, for example, is stored in the image memory 63. The processing unit 64 processes the input image. The network interface 65 is an interface for communicating with the server via the network.

The processing unit 64 comprises a processor which executes a program, and a memory for storing the program. That is, the processor executes the program stored in the memory so that the processing unit 64 achieves various kinds of processing. In the configuration example shown in FIG. 9, the processing unit 64 comprises, as functions enabled when the processor executes the program, a face detecting unit 72, a face detection result storage unit 73, a tracking result managing unit 74, a graph creating unit 75, a branch weight calculating unit 76, an optimum path set calculating unit 77, a tracking state judging unit 78, and an output unit 79.

The face detecting unit 72 is a function for detecting the region of a moving object when the moving object (the face of a person) is contained in an input image. The face detection result storage unit 73 is a function for storing images including the moving object as a detected tracking target over past several frames. The tracking result managing unit 74 is a function for managing tracking results. The tracking result managing unit 74 stores and manages tracking results obtained in later-described processing. When detection is unsuccessful in a frame during the movement of the object, the tracking result managing unit 74 again adds a tracking result or causes the output unit to output a processing result.

The graph creating unit 75 is a function for creating a graph from face detection results stored in the face detection result storage unit 73 and from tracking result candidates stored in the tracking result managing unit 74. The branch weight calculating unit 76 is a function for allocating weights to branches of the graph created by the graph creating unit 75. The optimum path set calculating unit 77 is a function for calculating a combination of paths that optimizes an objective function from the graph. The tracking state judging unit 78 is a function for judging whether the tracking is interrupted or the tracking is ended because the object has disappeared from the screen when there is a frame in which the detection of the object (face) is unsuccessful among tracking targets stored and managed by the tracking result managing unit 74. The output unit 79 is a function for outputting information such as tracking results output from the tracking result managing unit 74.

Now, the configuration and operation of each unit are described in detail.

The image interface 62 is an interface for inputting images including the face of a person targeted for tracking. In the configuration example shown in FIG. 9, the image interface 62 acquires pictures captured by the camera 51 for photographing an area targeted for monitoring. The image interface 62 digitizes the image acquired from the camera 51 by an A/D converter, and supplies the digitized images to the processing unit 24 or the image memory 23. The image (one or more face images or moving images captured by the camera 51) input to the image interface 62 is transmitted to the server 53 to match with the processing result by the processing unit 64 so that the tracking result or the face detection result can be viewed by the observer. When the camera 51 and each of the terminal devices 2 are connected via the communication line (network), the image interface 62 may comprise a network interface and an A/D converter.

The face detecting unit 72 performs processing to detect one or more faces in the input image. The technique described in the first embodiment can be applied as a specific processing method. For example, a prepared template is moved in an image to find a correlation value so that a position providing the highest correlation value is set as a face region. Otherwise, a face extraction method that uses an eigenspace method or a subspace method can be applied to the face detecting unit 72.

The face detection result storage unit 73 stores and manages detection results of the face targeted for tracking. In the third embodiment, the image in each of the frames of the pictures captured by the camera 51 is used as an input image, and “face information” corresponding to the number of face detection results obtained by the face detecting unit 72, the frame number of the moving image, and the number of detected faces is managed. The “face information” includes information such as the detection position (coordinates) of the face in the input image, identification information (ID information) provided to the identical person that is tracked, and a partial image (face image) of a detected face region.

For example, FIG. 10 is a diagram showing a configuration example of data that indicates face detection results stored in the face detection result storage unit 73. The example in FIG. 10 shows data for face detection results of three frames (t-1, t-2, and t-3). For the image of the frame t-1, information indicating that the number of detected faces is “3” and the “face information” for the three faces are stored in the face detection result storage unit 73 as data for a face detection result in the example shown in FIG. 10. For the image of the frame t-2, information indicating that the number of detected faces is “4” and the “face information” for the four faces are stored in the face detection result storage unit 73 as data for a face detection results in the example shown in FIG. 10. For the image of the frame t-3, information indicating that the number of detected faces is “2” and the “face information” for the two faces are stored in the face detection result storage unit 73 as data for a face detection results in the example shown in FIG. 10. Moreover, in the example shown in FIG. 10, two pieces of “face information” for the image of the frame t-T, two pieces of “face information” for the image of the frame t-T-1, and three pieces of “face information” for the image of the frame t-T-T′ are stored in the face detection result storage unit 73 as data for face detection results.

The tracking result managing unit 74 stores and manages tracking results or detection results. For example, the tracking result managing unit 74 manages information tracked or detected from the preceding frame (t-1) to the frame t-T-T′ (T>=0 and T′>=0 are parameters). In this case, information indicating a detection result targeted for tracking processing is stored up to the frame image of t-T, and information indicating past tracking results is stored from the frame t-T-1 to the frame t-T-T′. The tracking result managing unit 74 may otherwise manage face information for the image of each frame.

The graph creating unit 75 creates a graph comprising peaks corresponding to states “unsuccessful detection during tracking”, “disappearance”, and “appearance”, in addition to peaks (face detection positions) corresponding to data for the face detection results stored in the face detection result storage unit 73 and the tracking results (information on the selected tracking target) managed in the tracking result managing unit 74. The “appearance” referred to here means a condition in which a person who is not present in the image of the preceding frame newly appears in the image of the subsequent frame. The “disappearance” means a condition in which a person present in the image of the preceding frame is not present in the image of the subsequent frame. The “unsuccessful detection during tracking” means a condition in which the face that is to be present in the frame image is unsuccessfully detected. The “false positive” may be captured into consideration for the peak to be added. This means a condition in which an object that is not a face is erroneously detected as a face. The addition of the peak provides the advantage that tracking accuracy can be prevented from decreasing due to detection accuracy.

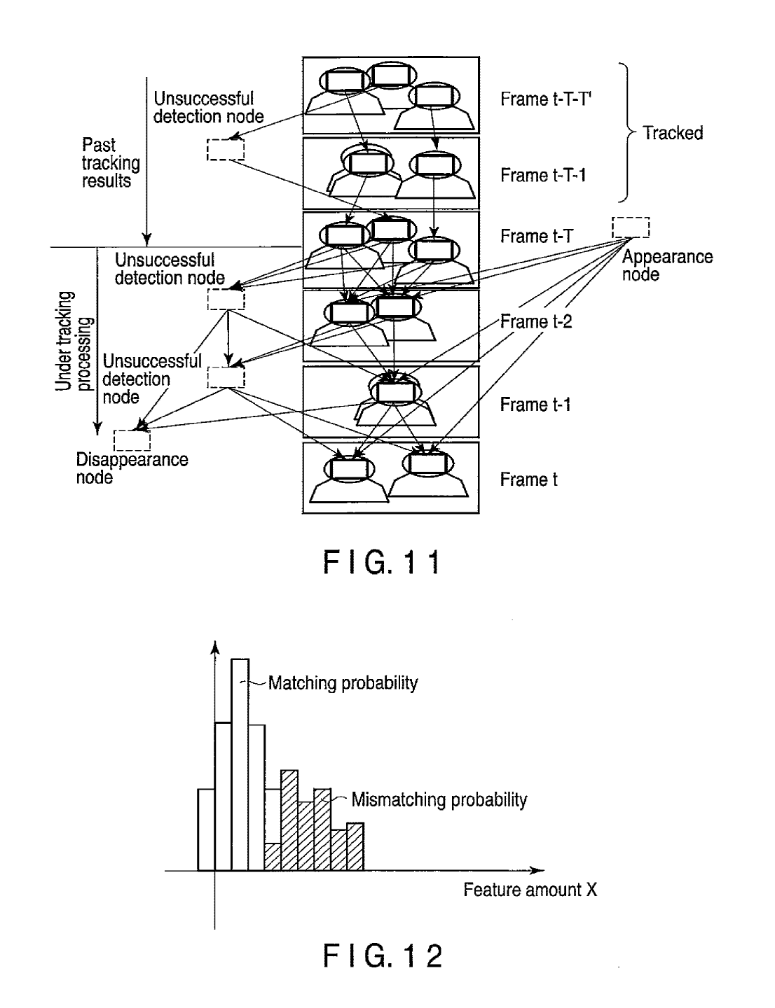

FIG. 11 is a diagram showing an example of a graph created by the graph creating unit 75. The example in FIG. 11 shows a combination of branches (paths) in which faces detected in the time-series images, an appearance, a disappearance, and an unsuccessful detection are defined as nodes. Moreover, the example in FIG. 11 shows a condition in which tracked paths are specified to reflect completed tracking results. When the graph shown in FIG. 11 is obtained, which of the paths shown in the graph is likely to be a tracking result is determined in the subsequent processing.

As shown in FIG. 11, in the present person tracking system, nodes corresponding to the unsuccessful detections of the face in the image being tracked in the tracking processing are added. Thus, the advantage of the person tracking system as a moving object tracking system according to the present embodiment is that even when there is a frame image in which detection is temporarily prevented during tracking, an object is correctly matched with the moving object (face) being tracked in the frame images before and after the above frame image, thus ensuring that the tracking of the moving object (face) can be continued.

The branch weight calculating unit 76 sets a weight, that is, a real value to a branch (path) set in the graph creating unit 75. This enables highly accurate tracking by considering both the probability of matching p(X) and the probability of mismatching q(X) between face detection results. In the example described in the present embodiment, a logarithm of the ratio between the matching probability p(X) and the mismatching probability q(X) is obtained to calculate a branch weight.

However, the branch weight has only to be calculated by considering the matching probability p(X) and the mismatching probability q(X). That is, the branch weight has only to be calculated as a value that indicates the relation between the matching probability p(X) and the mismatching probability q(X). For example, the branch weight may be a subtraction between the matching probability p(X) and the mismatching probability q(X). Alternatively, a function for calculating a branch weight may be created by using the matching probability p(X) and the mismatching probability q(X), and this predetermined function may be used to calculate a branch weight.

The matching probability p(X) and the mismatching probability q(X) can be obtained as feature amounts or random variables by using the distance between face detection results, the size ratio of face detection frames, a velocity vector, and a correlation value of a color histogram. A probability distribution is estimated by proper learning data. That is, the present person tracking system can prevent the confusion of tracking targets by considering both the probability of matching and the probability of mismatching between nodes.

For example, FIG. 12 is a graph showing an example of the probability of matching p(X) and the probability of mismatching q(X) between a peak u corresponding to the position of a face detected in a frame image and a peak v as the position of a face detected in a frame image following the former frame image. When the probability p(X) and the probability q(X) shown in FIG. 12 are provided, the branch weight calculating unit 76 uses a probability ratio log(p(X)/q(X)) to calculate a branch weight between the peak u and the peak v in the graph created by the graph creating unit 75.

In this case, the branch weight is calculated as the following value depending on the values of the probability p(X) and the probability q(X).

If p(X)>q(X)=0(case A),log(p(X)/q(X))=+∞

If p(X)>q(X)>0(case B),log(p(X)/q(X))=a(X)

If q(X)≥p(X)>0(case C),log(p(X)/q(X))=−b(X)

If q(X)≥p(X)=0(case D),log(p(X)/q(X))=−∞

Nor that, a(X) and b(X) are nonnegative real values, respectively.

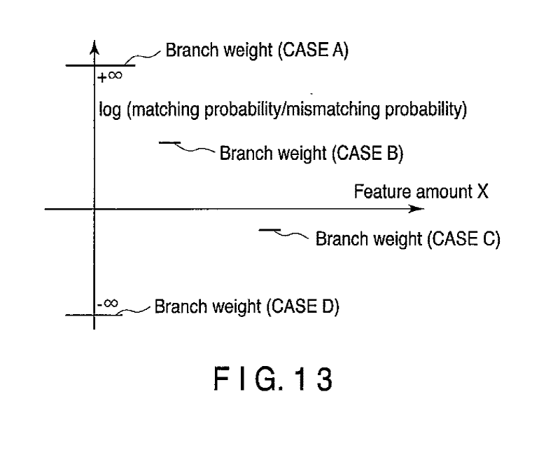

FIG. 13 is a graph conceptually showing the values of branch weights in the above cases A to D.

In the case A, as the mismatching probability q(X) is “0” and the matching probability p(X) is not “0”, the branch weight is +∞. The branch weight is positively infinite so that a branch is always selected in an optimization calculation.

In the case B, as the matching probability p(X) is greater than the mismatching probability q(X), the branch weight is a positive value. The branch weight is a positive value so that this branch is high in reliability and likely to be selected in an optimization calculation.

In the case C, as the matching probability p(X) is smaller than the mismatching probability q(X), the branch weight is a negative value. The branch weight is a negative value so that this branch is low in reliability and is not likely to be selected in an optimization calculation.

In the case D, as the matching probability p(X) is “0” and the mismatching probability q(X) is not “0”, the branch weight is −∞. The branch weight is positively infinite so that this branch is never selected in an optimization calculation.

The branch weight calculating unit 76 calculates a branch weight by logarithmic values of the probability of disappearance, the probability of appearance, and the probability of unsuccessful detection during tracking. These probabilities can be determined by previous learning using corresponding data (e.g., data stored in the server 53). Moreover, even when one of the matching probability p(X) and the mismatching probability q(X) is not accurately estimated, this issue can be addressed by providing the value of a given X with a constant value; for example, p(X)=constant value or q(X)=constant value.

The optimum path set calculating unit 77 calculates the total of the values of allocated branch weights calculated by the branch weight calculating unit 76 with regard to the combination of the paths in the graph created by the graph creating unit 75, and calculates (optimization calculation) a combination of the paths that maximizes the total of the branch weights. A well-known combinational optimization algorithm can be used for this optimization calculation.

For example, if the probability described in connection with the branch weight calculating unit 76 is used, the optimum path set calculating unit 77 can find a combination of the paths providing the maximum posterior probability by the optimization calculation. A face continuously tracked from a past frame, a face that has newly appeared, and a face that has not been matched are obtained by finding the optimum path combination. The optimum path set calculating unit 77 records the result of the optimization calculation in the tracking result managing unit 74.

The tracking state judging unit 78 judges a tracking state. For example, the tracking state judging unit 78 judges whether the tracking of the tracking target managed in the tracking result managing unit 74 has ended. When judging that the tracking has ended, the tracking state judging unit 78 informs the tracking result managing unit 74 of the end of the tracking so that a tracking result is output to the output unit 79 from the tracking result managing unit 74.

If there is a frame in which a face as a moving object is unsuccessfully detected among tracking targets, the tracking state judging unit 78 judges whether this is attributed to the interruption of the tracking (unsuccessful detection) during tracking or the end of the tracking caused by disappearance from the frame image (captured image). Information including the result of such a judgment is reported to the tracking result managing unit 74 from the tracking state judging unit 78.

The tracking state judging unit 78 outputs a tracking result from the tracking result managing unit 74 to the output unit 79 by the following standards: A tracking result is output frame by frame. A tracking result is output in case of inquiry from, for example, the server 53. Tracking information for matched frames is collectively output at the point where it is judged that there is no more person to be tracked in the screen. A tracking result is output by once judging that the tracking has ended when frames equal to or more than given frames are tracked.

The output unit 79 outputs information including the tracking results managed in the tracking result managing unit 74 to the server 53 which functions as a picture monitor device. Otherwise, the terminal device 52 may be provided with a user interface having a display unit and an operation unit so that the operator can monitor pictures and tracking results. In this case, the information including the tracking results managed in the tracking result managing unit 74 can be displayed on the user interface of the terminal device 52.

As the information managed in the tracking result managing unit 74, the output unit 79 outputs, to the server 53, face information, that is, the detection position of a face in an image, the frame number of moving images, ID information individually provided to the identical person that is tracked, and information (e.g., photography place) on an image in which a face is detected.

For the identical person (tracked person), the output unit 79 may output, for example, coordinates of a face in more than one frame, a size, a face image, a frame number, time, information on the summary of features, or information that matches the former information with images recorded in a digital video recorder (pictures stored in, for example, the image memory 63). Moreover, face region images to be output may only be all of the images being tracked or some of the images that are regarded as optimum under predetermined conditions (e.g., a face size, direction, whether eyes are open, whether an illumination condition is proper, or whether the likelihood of a face at the detection of a face is high).

As described above, according to the person tracking system of the third embodiment, the number of useless collations can be reduced and a load on the system can be lessened even when a great volume of face images detected from frame images of moving images input from, for example, monitor cameras are collated with the database. Moreover, even when the identical person makes complex movements, face detection results in frames can be reliably matched including unsuccessful detections, and a highly accurate tracking result can be obtained.

The person tracking system described above tracks a person (moving object) making complex behavior from images captured by a large number of cameras, and transmits information on a person tracking result to the server while reducing the load of a communication amount in the network. Thus, even if there is a frame in which a person targeted for tracking is unsuccessfully detected during the movement of this person, the person tracking system enables stable tracking of persons without discontinuing the tracking.

Furthermore, the person tracking system can record a tracking result in accordance with the reliability of the tracking of a person (moving object), or manage identification results of the tracked person. Thus, the person tracking system advantageously prevents the confusion of persons in tracking more than one person. Moreover, the person tracking system successively outputs tracking results targeted for past frame images dating back to an N frame from a current point, which means that on-line tracking can be performed.

According to the person tracking system described above, a picture can be recorded or a person (moving object) can be identified on the basis of an optimum tracking result when tracking is properly performed. Moreover, according to the person tracking system described above, when it is judged that a tracking result is complex and there may be more than one tracking result candidate, tracking result candidates are presented to the operator in accordance with the condition of a communication load or the reliability of the tracking result, or the tracking result candidates can be used to ensure the recording and displaying of pictures or the identification of a person.

Now, the fourth embodiment is described with reference to the drawings.

In the fourth embodiment, a moving object tracking system (person tracking system) for tracking a moving object (person) appearing in time-series images obtained from cameras is described. The person tracking system detects the face of a person from the time-series images obtained from the cameras, and when more than one face can be detected, the person tracking system tracks the faces of these persons. The person tracking system described in the fourth embodiment is also applicable to a moving object tracking system intended for other moving objects (e.g., a vehicle or an animal) by changing a moving object detecting method suitably to such a moving object.

Moreover, the moving object tracking system according to the fourth embodiment detects a moving object (e.g., a person, a vehicle or an animal) from a great volume of moving images collected from monitor cameras, and records the corresponding scenes in a recording device together with the tracking result. The moving object tracking system according to the fourth embodiment also functions as a monitor system for tracking a moving object (e.g., a person or a vehicle) photographed by monitor cameras, and collating the tracked moving object with dictionary data previously registered on a database to identify the moving object, and then reporting the identification result of the moving object.

The moving object tracking system according to the fourth embodiment described below targets, for tracking, persons (faces of persons) present in images captured by the monitor cameras in accordance with tracking processing to which a properly set tracking parameter is applied. Moreover, the moving object tracking system according to the fourth embodiment judges whether a person detection result is appropriate for the estimation of the tracking parameter. The moving object tracking system according to the fourth embodiment uses the person detection result judged to be appropriate for the estimation of the tracking parameter as information for learning the tracking parameter.

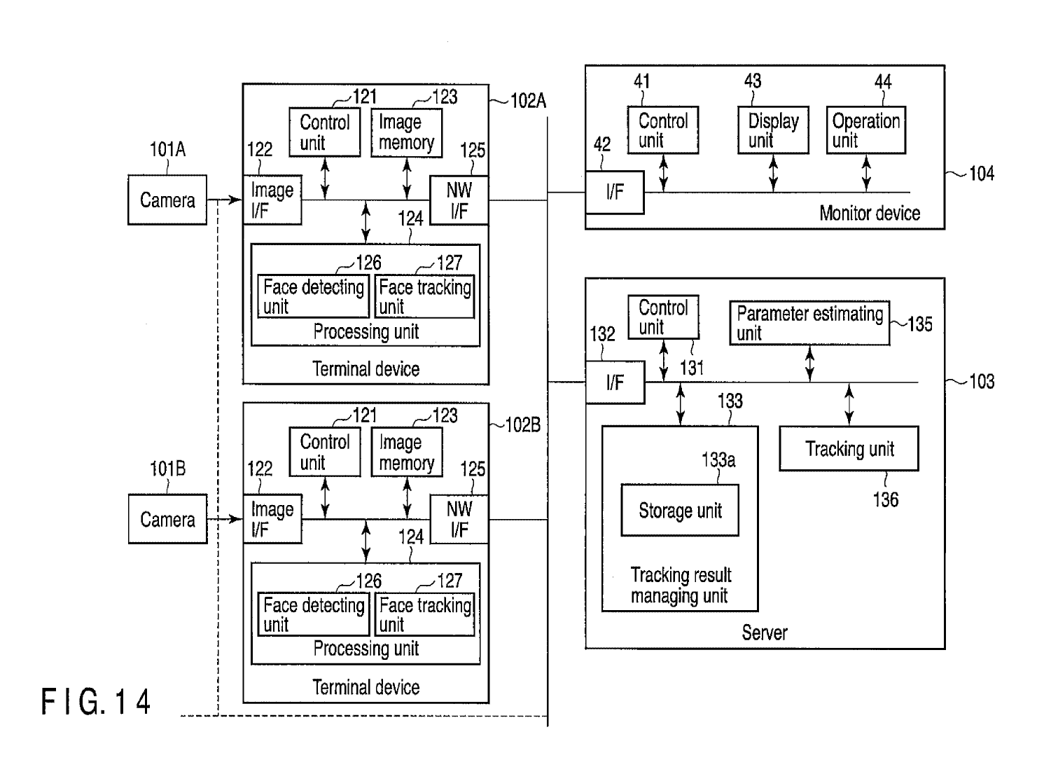

FIG. 14 is a diagram showing a hardware configuration example of the person tracking system according to the fourth embodiment.

The person tracking system according to the fourth embodiment shown in FIG. 14 comprises cameras 101 (101A, 101B), terminal devices 102 (102A, 102), a server 103, and a monitor device 104. The cameras 101 (101A, 101B) and the monitor device 104 shown in FIG. 14 can be similar to the cameras 1 (1A, 1B) and the monitor device 1 shown in FIG. 2 and others.

Each of the terminal devices 102 comprises a control unit 121, an image interface 122, an image memory 123, a processing unit 124, and a network interface 125. The control unit 121, the image interface 122, the image memory 123, and the network interface 125 can be similar in configuration to the control unit 21, the image interface 22, the image memory 23, and the network interface 25 shown in FIG. 2 and others.

Similarly to the processing unit 24, the processing unit 124 comprises a processor which operates in accordance with a program, and a memory in which the program to be executed by the processor is stored. As processing functions, the processing unit 124 comprises a face detecting unit 126 which detects a region of a moving object when the moving object (the face of a person) is included in an input image, and a scene selecting unit 127. The face detecting unit 126 has function for performing processing similar to that in the face detecting unit 26. That is, the face detecting unit 126 detects information (a region of a moving object) indicating the face of a person as a moving object from the input image. The scene selecting unit 127 selects a movement scene (hereinafter also referred to simply as a scene) of the moving object for use in the later-described estimation of the tracking parameter from the detection results by the face detecting unit 126. The scene selecting unit 127 will be described in detail later.

The server 103 comprises a control unit 131, a network interface 132, a tracking result managing unit 133, a parameter estimating unit 135, and a tracking unit 136. The control unit 131, the network interface 132, and the tracking result managing unit 133 can be similar to the control unit 31, the network interface 32, and the tracking result managing unit 33 shown in FIG. 2 and others.

The parameter estimating unit 135 and the tracking unit 136 each comprises a processor which operates in accordance with a program, and a memory in which the program to be executed by the processor is stored. That is, the processor executes the program stored in the memory so that the parameter estimating unit 135 achieves processing such as parameter setting processing. The processor executes the program stored in the memory so that the tracking unit 136 achieves processing such as tracking processing. The parameter estimating unit 135 and the tracking unit 136 may otherwise be obtained in such a manner that the processor executes the program in the control unit 131.

The parameter estimating unit 135 estimates a tracking parameter that indicates the standard for tracking the moving object (the face of a person) in accordance with the scene selected by the scene selecting unit 127 of the terminal device 2, and outputs the estimated tracking parameter to the tracking unit 136. The tracking unit 136 matches and tracks the identical moving objects (the faces of the persons) detected from the images by the face detecting unit 126, in accordance with the tracking parameter estimated by the parameter estimating unit 135.

The scene selecting unit 127 is described next.

The scene selecting unit 127 judges whether a detection result by the face detecting unit 126 is appropriate for the estimation of the tracking parameter. The scene selecting unit 127 performs two-stage processing including scene selecting processing and tracking result selecting processing.

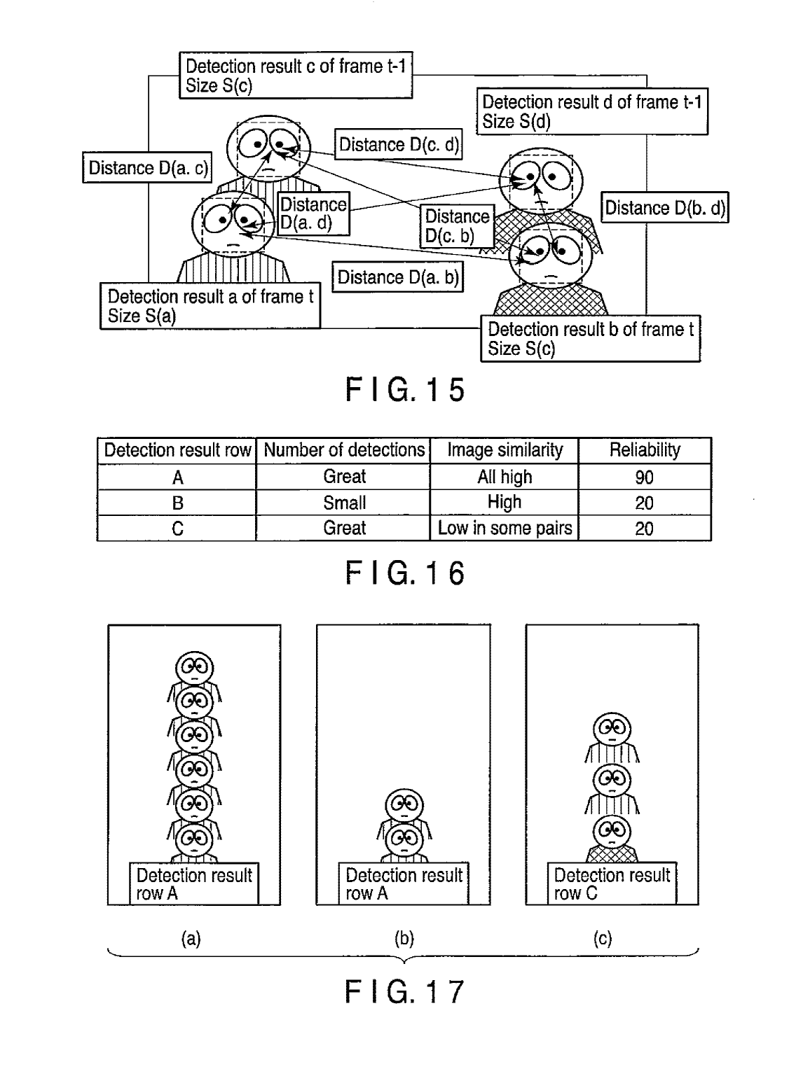

First, the scene selecting processing determines a reliability as to whether a detection result row can be used for the estimation of the tracking parameter. The scene selecting processing judges a reliability on the basis of the face that the number of frames equal to or more than a predetermined threshold can be detected and the face that detection result rows of persons are not confused. For example, the scene selecting unit 127 calculates a reliability from the relation of the positions of the detection result rows. The scene selecting processing is described with reference to FIG. 15. For example, when there is one detection result (detected face) in a given number of frames, it is estimated that there is only one person moving if the detected face has moved in a range smaller than a predetermined threshold. In the example shown in FIG. 15, whether one person is moving between frames is judged by whether

D(a,c)<rS(c)

is satisfied wherein a is a detection result in a t frame, and c is a detection result in a t-1 frame. However, D(a, b) is the distance (pixel) between a and b in an image, S(c) is the size (pixel) of the detection result. r is a parameter.

Even when there is more than face detection result, a movement sequence of the identical person is obtained if faces are moving at distant positions in an image within a range smaller than the predetermined threshold. This is used for learning the tracking parameter. In order to classify, person by person, the detection result rows of the persons, a judgment is made by comparing the pair of detection results between frames as follows:

D(ai,aj)>C,D(ai,cj)>C,D(ai,ci)<rS(ci),D(aj,cj)<rS(cj)

wherein ai and aj are detection results in the t frame, and ci, cj are detection results in the t-1 frame. However, D(a, b) is the distance (pixel) between a and b in an image, S(c) is the size (pixel) of the detection result. r and c are parameters.

The scene selecting unit 127 can also select a scene by using an image feature amount to perform a regression analysis of the condition in which persons are dense in an image. Further, the scene selecting unit 127 can perform person identifying processing using images of detected faces in frames only during learning and thereby obtain a movement sequence individually for the identical person.

In order to exclude erroneous detection results, the scene selecting unit 127 excludes a detection result in which the size for the detected position has a variation equal to or less than a predetermined threshold, excludes a detection result having a movement equal to or less than a predetermined movement, or excludes a detection result using character recognition information obtained by character recognition processing of the image of the surrounding. Thus, the scene selecting unit 127 can exclude erroneous detections attributed to posters or characters.

The scene selecting unit 127 provides, to data, the number of frames from which face detection results are obtained, and the reliability corresponding to the number of detected faces. The reliability is generally determined by information such as the number of frames from which faces are detected, the number of detected faces (the number of detections), the movement amount of the detected face, and the size of the detected face. The scene selecting unit 127 can calculate the reliability by, for example, the reliability calculation method described with reference to FIG. 2.

FIG. 16 shows an example of numerical values of the reliabilities of detection result rows. FIG. 16 is a diagram corresponding to FIG. 17 described later. The reliabilities shown in FIG. 16 can be calculated on the basis of, for example, a prepared tendency (the value of image similarity) of successful tracking examples and unsuccessful tracking examples.

The numerical values of the reliabilities can be determined on the basis of the number of frames in which tracking is successful, as shown in FIGS. 17(a), (b) and (c). A detection result row A in FIG. 17(a) indicates the case in which a sufficient number of frames are sequentially output regarding the face of the identical person. A detection result row B in FIG. 17(b) indicates the case in which the frames regard the identical person but are small in number. A detection result row C in FIG. 17(c) indicates the case in which a different person is included. As shown in FIG. 17, a low reliability can be set for the case where there are only a small number of frames in which tracking is successful. These standards can be combined together to calculate a reliability. For example, when there are a large number of frames in which tracking is successful but the similarity of face images is low on average, a higher reliability can be set for a tracking result showing a small number of frames but showing a high similarity.

The tracking result selecting processing is described next.

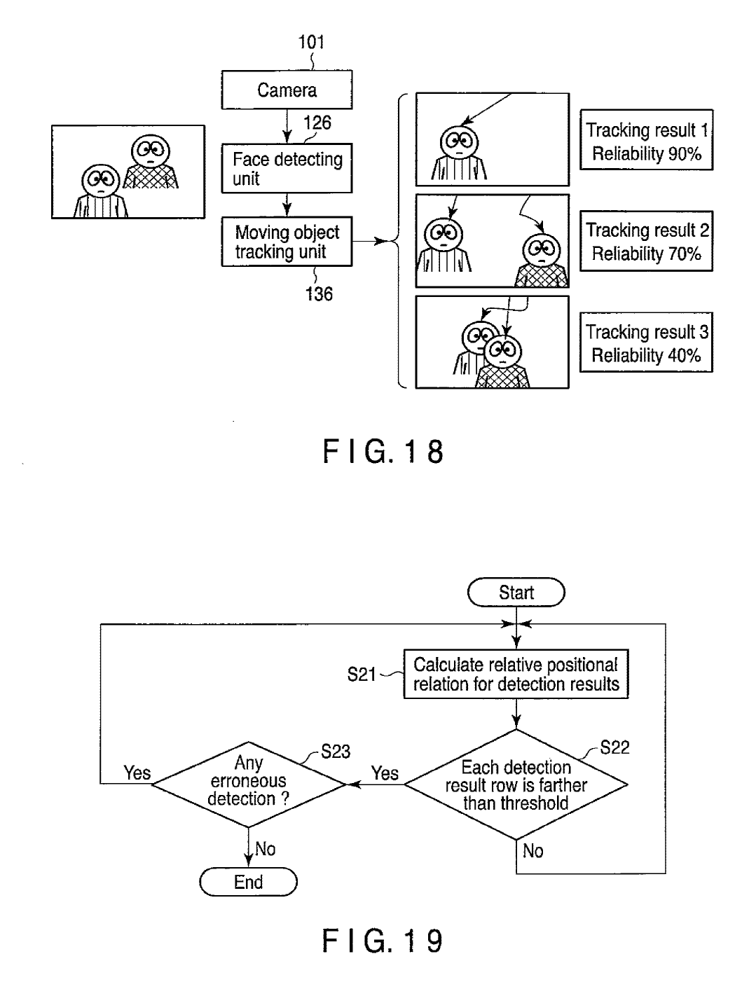

FIG. 18 is a diagram showing an example of the results (tracking results) of a moving object (person) using a proper tracking parameter.

In the tracking result selecting processing, the scene selecting unit 127 judges whether each tracking result is likely to be a correct tracking result. For example, when tracking results shown in FIG. 18 are obtained, the scene selecting unit 127 judges whether each tracking result is likely to show correct tracking. When judging that the tracking result is correct, the scene selecting unit 127 outputs this tracking result to the parameter estimating unit 135 as data (data for learning) for estimating a tracking parameter. For example, when traces of tracked persons cross each other, there is a probability that the ID information of the tracking target may be wrongly changed, so that the scene selecting unit 127 sets a low reliability. For example, when the threshold for the reliability is set at a “reliability of 70% or more”, the scene selecting unit 127 outputs, for learning, a tracking result 1 and a tracking result 2 that have a reliability of 70% or more out of tracking results shown in FIG. 18.

FIG. 19 is a flowchart for illustrating the example of the tracking result selecting processing.

As shown in FIG. 19, the scene selecting unit 127 calculates a relative positional relation for the detection results of input frames, as the tracking result selecting processing (step S21). The scene selecting unit 127 judges whether the calculated relative positional relation is farther than a predetermined threshold (step S22). When the calculated relative positional relation is farther than the predetermined threshold (step S22, YES), the scene selecting unit 127 checks whether there is any erroneous detection (step S23). When it is ascertained that there is no erroneous detection (step S23, YES), the scene selecting unit 127 judges that this detection result is a scene appropriate for the estimation of the tracking parameter (step S24). In this case, the scene selecting unit 127 transmits the detection result (including a moving image row, a detection result row, and a tracking result) judged to be a scene appropriate for the estimation of the tracking parameter to the parameter estimating unit 135 of the server 103.

The parameter estimating unit 135 is described next.

The parameter estimating unit 135 estimates a tracking parameter by using the moving image row, the detection result row, and the tracking result that are obtained from the scene selecting unit 127. For example, suppose that the scene selecting unit 127 observes the obtained N data D={X1, . . . , XN} for a proper random variable X. For example, average of D μ=(X1+X2+ . . . +XN)/N and dispersion ((X1−μ)2+ . . . +(XN−μ)2)/N are estimated values given that X follows a normal distribution when θ is the parameter of the probability distribution of X.

The parameter estimating unit 135 may directly calculate a distribution instead of estimating a tracking parameter. Specifically, the parameter estimating unit 135 calculates a posterior probability p(θ|D), and calculates a matching probability by p(X|D)=∫p(X|θ) p(θ|D)dθ. This posterior probability can be calculated by p(θ|D)=p(θ) p(D|θ)/p(D) if the prior probability p(θ) of θ and the likelihood p(X|θ) are determined as in the normal distribution.

As an amount used as the random variable, the amount of the movement of moving objects (faces of persons), a detection size, the similarities of various image feature amounts, and a moving direction may be made. The tracking parameter is an average or a variance-covariance matrix in the case of, for example, the normal distribution. However, various probability distributions may be used for the tracking parameter.

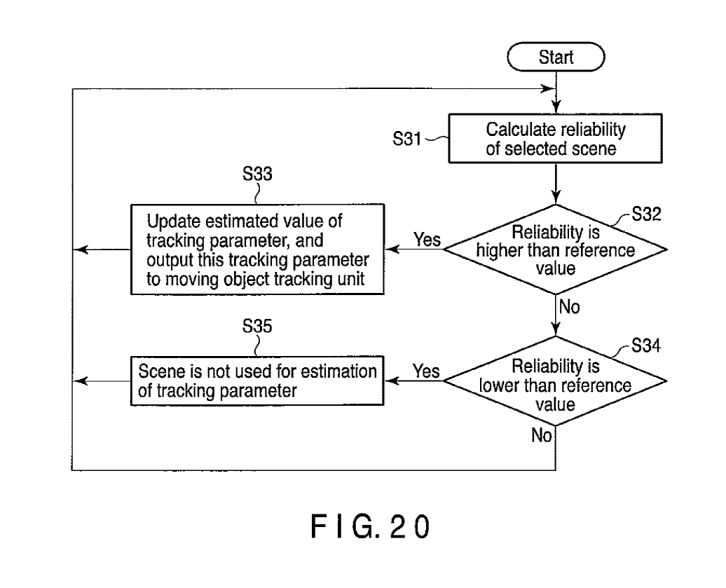

FIG. 20 is a flowchart for illustrating a processing procedure for the parameter estimating unit 135. As shown in FIG. 20, the parameter estimating unit 135 calculates a reliability of a scene selected by the scene selecting unit 127 (step S31). The parameter estimating unit 135 judges whether the obtained reliability is higher than a predetermined reference value (threshold) (step S32). When judging that the reliability is higher than the reference value (step S32, YES), the parameter estimating unit 135 updates the estimated value of the tracking parameter on the basis of the scene, and outputs the updated value of the tracking parameter to the tracking unit 136 (step S33). When the reliability is not higher than the reference value, the parameter estimating unit 135 judges whether the reliability is higher than the predetermined reference value (threshold) (step S34). When judging that the obtained reliability is lower than the reference value (step S34, YES), the parameter estimating unit 135 does not use the scene selected by the scene selecting unit 127 for the estimation (learning) of the tracking parameter, and does not estimate any tracking parameter (step S35).

The tracking unit 136 is described next.

The tracking unit 136 performs optimum matching by integrating information such as the coordinates and size of the face of a person detected in the input images. The tracking unit 136 integrates tracking results in which the identical persons are matched in the frames, and outputs the integration result as a tracking result. When there is a complex movement such as crossing of persons an image in which persons are walking, a single matching result may not be determined. In this case, the tracking unit 136 can not only output a result having the highest likelihood in the matching as a first candidate but also manage the proportionate matching results (i.e., output more than one tracking result).

The tracking unit 136 may output a tracking result through an optical flow or a particle filter which is a tracking technique for predicting the movement of a person. Such processing can be performed by a technique described in, for example, a document (Kei Takizawa, Mitsutake Hasebe, Hiroshi Sukegawa, Toshio Sato, Nobuyoshi Enomoto, Bunpei Irie, and Akio Okazaki: “Development of a Face Recognition System for Pedestrians, “Face Passenger”, 4th Forum on Information Technology (FIT2005), pp. 27-28).

As a specific tracking technique, the tracking unit 136 can be provided by a unit having processing functions similar to the tracking result managing unit 74, the graph creating unit 75, the branch weight calculating unit 76, the optimum path set calculating unit 77, and the tracking state judging unit 78 that are described in the third embodiment and shown in FIG. 9.

In this case, the tracking unit 136 manages information tracked or detected from the preceding frame (t-1) to the frame t-T-T′ (T>=0 and T′>=0 are parameters). The detection results up to t-1 are detection results targeted for tracking processing. The detection results from t-T-1 to t-T-T′ are past tracking results. The tracking unit 136 manages face information (a position in an image included in a face detection result obtained from the face detecting unit 126, the frame number of moving images, ID information individually provided to the identical person that is tracked, and a partial mage of a detected region) for each frame.

The tracking unit 136 creates a graph comprising peaks corresponding to states “unsuccessful detection during tracking”, “disappearance”, and “appearance”, in addition to peaks corresponding to face detection information and tracking target information. Here, the “appearance” means a condition in which a person who is not present in the screen newly appears in the screen. The “disappearance” means a condition in which a person present in the screen disappears from the screen. The “unsuccessful detection during tracking” means a condition in which the face that is to be present in the screen is unsuccessfully detected. The tracking result corresponds to a combination of paths on this graph.

A node corresponding to the unsuccessful detection during tracking is added. Thus, even when there is a frame in which detection is temporarily prevented during tracking, the tracking unit 136 correctly performs matching using the frames before and after the above frame and can thus continue tracking. A weight, that is, a real value is set for a branch set in the graph creation. This enables more accurate tracking by considering both the probability of matching and the probability of mismatching between face detection results.

The tracking unit 136 determines a logarithm of the ratio between the two probabilities (the matching probability and the mismatching probability). However, as long as the two probabilities are considered, the subtraction of the probability can be performed or a predetermined function f (P1 and P2) can be created. As feature amounts or random variables, the distance between face detection results, the size ratio of detection frames, a velocity vector, and a correlation value of a color histogram can be used. The tracking unit 136 estimates a probability distribution by proper learning data. That is, the tracking unit 136 advantageously prevents the confusion of tracking targets by considering the mismatching probability as well.

When the matching probability p(X) and the mismatching probability q(X) of face detection information u and v between frames are provided for the above-mentioned feature amounts, a probability ratio log(p(X)/q(X)) is used to determine a branch weight between the peak u and the peak v in the graph. In this case, the branch weight is calculated as follows:

If p(X)>q(X)=0(case A),log(p(X)/q(X))=+∞

If p(X)>q(X)>0(case B),log(p(X)/q(X))=a(X)

If q(X)≥p(X)>0(case C),log(p(X)/q(X))=−b(X)

If q(X)≥p(X)=0(case D),log(p(X)/q(X))=−∞.

Not that a(X) and b(X) are nonnegative real values, respectively. In the case A, as the mismatching probability q(X) is 0 and the matching probability p(X) is not 0, the branch weight is +∞, and a branch is always selected in an optimization calculation. The same applies to the other cases (case B, case C and case D).

The tracking unit 136 determines a branch weight by logarithmic values of the probability of disappearance, the probability of appearance, and the probability of unsuccessful detection during tracking. These probabilities can be determined by previous learning using corresponding data. In the created graph including branch weights, the tracking unit 136 calculates a combination of the paths that maximizes the total of the branch weights. This can be easily found by a well-known combinational optimization algorithm. For example, if the probability described above is used, a combination of the paths providing the maximum posterior probability can be found. The tracking unit 136 can obtain a face continuously tracked from a past frame, a face that has newly appeared, and a face that has not been matched by finding the optimum path combination. Thus, the tracking unit 136 records the result of the processing described above in a storage unit 133a of the tracking result managing unit 133.

Now, the flow of the overall processing according to the fourth embodiment is described.

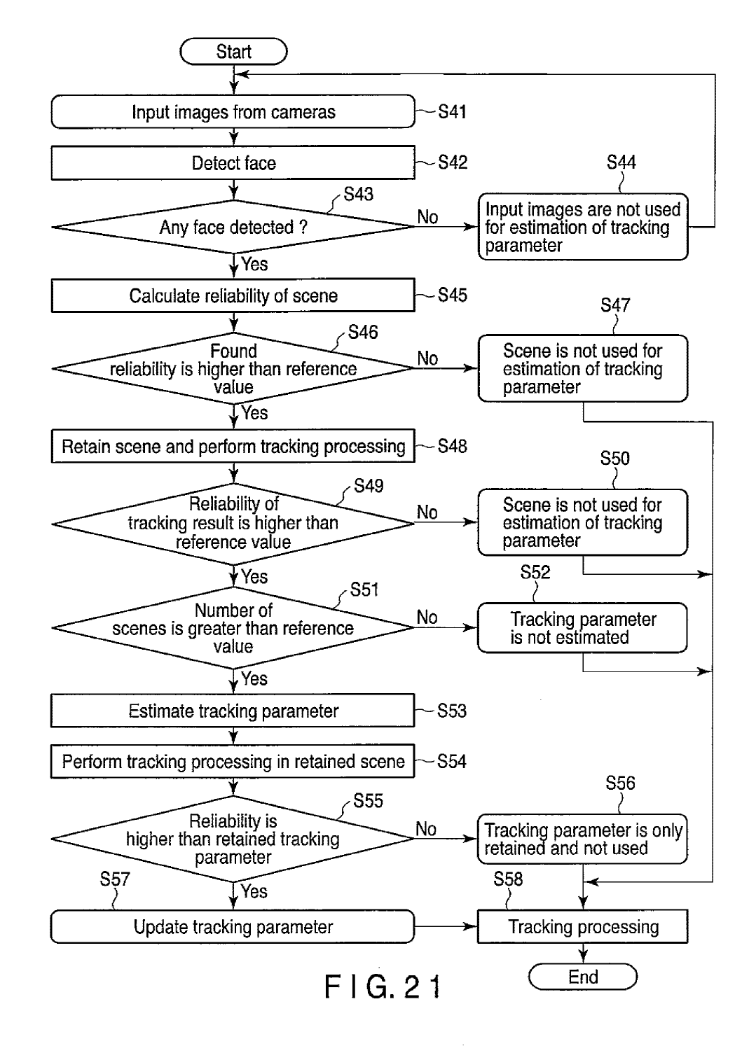

FIG. 21 is a flowchart for illustrating the flow of the overall processing according to the fourth embodiment.

Time-series images captured by the cameras 101 are input to each of the terminal devices 102 by the image interface 122. In each of the terminal devices 102, the control unit 121 digitizes the time-series images input from the cameras 101 by the image interface, and supplies the digitized images to the face detecting unit 126 of the processing unit 124 (step S41). The face detecting unit 126 detects a face as a moving object targeted for tracking from the input frames of images (step S42).

When the face detecting unit 126 does not detect any face from the input images (step S43, NO), the control unit 121 does not use the input images for the estimation of the tracking parameter (step S44). In this case, no tracking processing is performed. When a face can be detected from the input images (step S43, YES), the scene selecting unit 127 calculates, from a detection result output by the face detecting unit 126, a reliability for judging whether the scene of the detection result can be used for the estimation of the tracking parameter (step S45).

After calculating the reliability of the detection result, the scene selecting unit 127 judges whether the calculated reliability of the detection result is higher than a predetermined reference value (threshold) (step S46). When judging that the calculated reliability of the detection result is lower than the reference value (step S46, NO), the scene selecting unit 127 does not use the detection result for the estimation of the tracking parameter (step S47). In this case, the tracking unit 136 performs the processing of tracking the person in the time-series input images by using the tracking parameter immediately before updated (step S58).

When judging that the calculated reliability of the detection result is higher than the reference value (step S46, YES), the scene selecting unit 127 retains (records) the detection result (scene), and calculates a tracking result based on this detection result (step S48). Moreover, the scene selecting unit 127 calculates a reliability of this tracking result, and judges whether the calculated reliability of the tracking result is higher than a predetermined reference value (threshold) (step S49).

When the reliability of the tracking result is lower than the reference value (step S49, YES), the scene selecting unit 127 does not use the detection result (scene) for the estimation of the tracking parameter (step S50). In this case, the tracking unit 136 performs the processing of tracking the person in the time-series input images by using the tracking parameter immediately before updated (step S58).

When judging that the reliability of the tracking result is higher than the reference value (step S49, YES), the scene selecting unit 127 outputs this detection result (scene) to the parameter estimating unit 135 as data for estimating a tracking parameter. The parameter estimating unit 135 judges whether the number of detection results (scenes) having high reliabilities is greater than a predetermined reference value (threshold) (step S51).

When the number of scenes having high reliabilities is smaller than the reference value (step S51, NO), the parameter estimating unit 13 does not estimate any tracking parameter (step S52). In this case, the tracking unit 136 performs the processing of tracking the person in the time-series input images by using the current tracking parameter (step S58).

When the number of scenes having high reliabilities is greater than the reference value (step S51, YES), the parameter estimating unit 135 estimates a tracking parameter on the basis of the scene provided from the scene selecting unit 127 (step S53). When the parameter estimating unit 135 estimates a tracking parameter, the tracking unit 136 performs the tracking processing in the scene retained in step S48 (step S54).

The tracking unit 136 performs the tracking processing by using both the tracking parameter estimated by the parameter estimating unit 135 and the retained tracking parameter immediately before updated. The tracking unit 136 compares the reliability of the result of tracking that uses the tracking parameter estimated by the parameter estimating unit 135 with the reliability of the result of tracking that uses the tracking parameter immediately before updated. When the reliability of the result of tracking that uses the tracking parameter estimated by the parameter estimating unit 135 is lower than the reliability of the tracking result that uses the tracking parameter immediately before updated (step S55), the tracking unit 136 only retains and does not use the tracking parameter estimated by the parameter estimating unit 135 (step S56). In this case, the tracking unit 136 performs the processing of tracking the person in the time-series input images by using the tracking parameter immediately before updated (step S58).

When the reliability based on the tracking parameter estimated by the parameter estimating unit 135 is higher than the reliability of the tracking parameter immediately before updated, the tracking unit 136 updates the tracking parameter immediately before updated, to the tracking parameter estimated by the parameter estimating unit 135 (step S57). In this case, the tracking unit 136 tracks the person (moving object) in the time-series input images in accordance with the updated tracking parameter (step S58).

As described above, the moving object tracking system according to the fourth embodiment finds a reliability of a tracking result of a moving object, and when the found reliability is high, the moving object tracking system estimates (learns) a tracking parameter and adjusts the tracking parameter for use in the tracking processing. According to the moving object tracking system of the fourth embodiment, when more than one moving object is tracked, the tracking parameter is adjusted for a variation originating from the change of photographing equipment or a variation originating from the change of photographing environments, so that the operator can save the trouble of teaching a right solution.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A moving object tracking system comprising:
an input unit which inputs time-series images captured by a camera;
a detection unit which detects all tracking target moving objects from each of the input images input by the input unit;
a tracking unit which obtains a tracking result of matching each moving object detected in a first image by the moving object detection unit with a moving object likely to be identical among the moving objects detected in a second image following the first image;
an output setting unit which sets a parameter for selecting a tracking result to be output by the tracking unit; and
an output unit which outputs the moving object tracking result by the tracking unit selected in accordance with the parameter set by the output setting unit.

2. The moving object tracking system according to claim 1, wherein
the tracking unit judges the reliability of the tracking result of the moving object, and
the output setting unit sets a threshold for the reliability of the tracking result to be output by the tracking unit.

3. The moving object tracking system according to claim 1, wherein
the tracking unit judges the reliability of the tracking result of the moving object, and
the output setting unit sets the number of tracking results to be output by the tracking unit.

4. The moving object tracking system according to claim 1, further comprising:
a measurement unit which measures a load of processing in the tracking unit, wherein the output setting unit sets a parameter in accordance with the load measured by the measurement unit.

5. The moving object tracking system according to claim 1, further comprising:
an information managing unit which registers feature information for a moving object targeted for identification; and
an identifying unit which identifies the moving object from which the tracking result is obtained, by reference to the feature information for the moving object registered in the information managing unit.

6. A moving object tracking system comprising:
an input unit which inputs time-series images captured by a camera;
a detection unit which detects tracking target moving objects from each of the input images input by the input unit;
a tracking unit which obtains a tracking result of matching, on the basis of a tracking parameter, each moving object detected in a first image by the detection unit with a moving object likely to be identical among the moving objects detected in a second image following the first image;
an output unit which outputs the tracking result by the tracking unit;
a selecting unit which selects a detection result of the moving object usable for the estimation of the tracking parameter from detection results by the detection unit; and
a parameter estimating unit which estimates the tracking parameter on the basis of the detection result of the moving object selected by the selecting unit and sets the estimated tracking parameter in the tracking unit.

7. The moving object tracking system according to claim 6, wherein the selecting unit selects a row of highly reliable detection results for the identical moving object from the detection results by the detection unit.

8. The moving object tracking system according to claim 6, wherein when the movement amount of the moving object in at least one or more images detected by the detection unit is equal to or more than a predetermined threshold or when the distance between the moving objects detected by the detection unit is equal to or more than a predetermined threshold, the selecting unit selects the detection results in such a manner as to differentiate the respective moving objects.

9. The moving object tracking system according to claim 6, wherein the selecting unit judges that the detection result of the moving object detected at the same place for a given period or more is an erroneous detection.

10. The moving object tracking system according to claim 6, wherein the parameter estimating unit finds a reliability of the detection result selected by the selecting unit, and estimates the tracking parameter on the basis of the detection result when the found reliability is higher than a predetermined reference value.

11. A moving object tracking method comprising:
inputting time-series images captured by a camera;
detecting all tracking target moving objects from each of the input images;
tracking each of the moving objects detected from a first image by the detection and each of the moving objects detected from a second image following the first image, in such a manner as to match these moving objects;
setting a parameter for selecting a tracking result to be output as a result of the tracking processing; and
outputting the moving object tracking result selected in accordance with the set parameter.

12. A moving object tracking method comprising:
inputting time-series images captured by a camera;
detecting tracking target moving objects from each of the input images;
tracking each moving object detected in a first image by the detection and a moving object likely to be identical among the moving objects detected in a second image following the first image, in such a manner as to match these moving objects on the basis of a tracking parameter;
outputting the tracking result by the tracking processing;
selecting a detection result of the moving object usable for the estimation of the tracking parameter from detection results;
estimating a value of the tracking parameter on the basis of the selected detection result of the moving object; and
updating the tracking parameter used in the tracking processing to the estimated tracking parameter.
